(19) United States
(12) Patent Application Publication
(10) Pub. No.: US 2026/0086730 A1
(43) Pub. Date: Mar. 26, 2026

(54) REMOTE VOLUME CLONE

(71) Applicant: NetApp, Inc., San Jose, CA (US)

(72) Inventors: Anil Paul Thoppil, Pleasanton, CA (US); Manan Patel, San Francisco, CA (US); Ananthan Subramanian, San Ramon, CA (US); Garima Choudhary, San Jose, CA (US)

(73) Assignee: NetApp, Inc., San Jose, CA (US)

(21) Appl. No.: 19/334,299

(22) Filed: Sep. 19, 2025

Related U.S. Application Data
(60) Provisional application No. 63/696,992, filed on Sep. 20, 2024.

(51) Int. Cl. G06F 3/06

(52) U.S. Cl. CPC G06F 3/065; G06F 3/0619; G06F 3/0689

(57) ABSTRACT

Systems and methods for implementation and use of remote clone volumes within a distributed storage system are provided. In one of various contemplated examples, all nodes of multiple nodes of a cluster representing a distributed storage system are able to access an entirety of a global physical volume block number (PVBN) space of a storage pod. A remote clone volume of a parent volume of a source node may be created for use by a destination node by creating a dummy volume on the destination node. The dummy volume may then be converted into the remote clone volume by copying metadata associated with a backing snapshot of the parent volume to the dummy volume. After completing creation of the remote clone volume, the backing snapshot may then be locked to protect the backing snapshot from deletion.

### CROSS-REFERENCE TO RELATED APPLICATIONS

This application claims the benefit of priority of US Provisional Application No. 63/696,992, filed on September 20, 2024, which is hereby incorporated by reference in its entirety for all purposes.

### BACKGROUND

### FIELD

Various embodiments of the present disclosure generally relate to storage systems. In particular, some embodiments relate to the implementation and use of remote volume cloning in the context of a disaggregated storage space provided by a storage pod of a distributed storage system having a disaggregated storage architecture.

### DESCRIPTION OF THE RELATED ART

Distributed storage systems generally take the form of a cluster of storage controllers (or nodes in virtual or physical form). As a result of sub-optimal infrastructure architectures, prior scale-out storage solutions do not effectively utilize all three vectors of infrastructure (i.e., compute, network, and storage). For example, as shown in FIG. 5, each node of a distributed storage system may be associated with a dedicated pool of storage space (e.g., a node-level aggregate representing a file system that holds one or more volumes created over one or more RAID groups and which is only accessible from a single node at a time), thereby creating storage silos.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating a plurality of nodes interconnected as a cluster in accordance with an embodiment of the present disclosure.

FIG. 2 is a block diagram illustrating a node in accordance with an embodiment of the present disclosure.

FIG. 3 is a block diagram illustrating a storage operating system in accordance with an embodiment of the present disclosure.

FIG. 4 is a block diagram illustrating a tree of blocks representing of an example a file system layout in accordance with an embodiment of the present disclosure.

FIG. 5 is a block diagram illustrating a distributed storage system architecture in which the entirety of a given disk and a given RAID group are owned by an aggregate and the aggregate file system is only visible from one node, thereby resulting in silos of storage space.

FIG. 6 is a block diagram illustrating a distributed storage system architecture that provides disaggregated storage in accordance with an embodiment of the present disclosure.

FIG. 7 is a block diagram illustrating a cluster of nodes in which multiple remote clone volumes have been created in accordance with an embodiment of the present disclosure.

FIG. 8 is a flow diagram illustrating operations for performing remote clone volume creation in accordance with a first embodiment of the present disclosure.

FIGS. 9A-C are block diagrams conceptually illustrating the step-by-step performance of the operations of FIG. 8.

FIG. 10 is a flow diagram illustrating operations for performing remote clone volume creation in accordance with a second embodiment of the present disclosure.

FIGS. 11A-C are block diagrams conceptually illustrating the step-by-step performance of the operations of FIG. 10.

FIG. 12 is a block diagram conceptually illustrating a portion of a buffer tree containing information regarding a container or file in accordance with an embodiment of the present disclosure.

### DETAILED DESCRIPTION

Systems and methods are described for implementation and use of remote clone volumes within a distributed storage system. Clone volumes are typically created within the same file system aggregate (and hence, within the same node) as the parent volume. While such “same node” or “local” clone volumes are useful for certain scenarios, they do not address scenarios, for example, involving use of a dataset by multiple nodes, compute load sharing, and/or isolation. There are situations in which it may be desirable to provide access to the same data from multiple nodes of a cluster without any data copy and with the same latency as the original (parent) node. For example, for a workload having bursts of read activity (e.g., Artificial Intelligence (AI) workloads), it may be beneficial to have the ability to create one or more remote clone volumes (within one or more different file systems (which may be referred to herein as “dynamically extensible file systems”) of one or more different nodes of the cluster) so as to offload at least some portion of the computational impact of the read bursts to the one or more other nodes within the cluster. Similarly, test and development environments may benefit from the use of remote clone volumes since they can be isolated from production nodes in the cluster. As yet another example, analytics workflows can also take advantage of a remote clone, for example, by spinning up one or more stateless nodes on demand and attaching the desired volume to the stateless node(s). Remote clones can be also leveraged by backup workloads to avoid load on the production nodes.

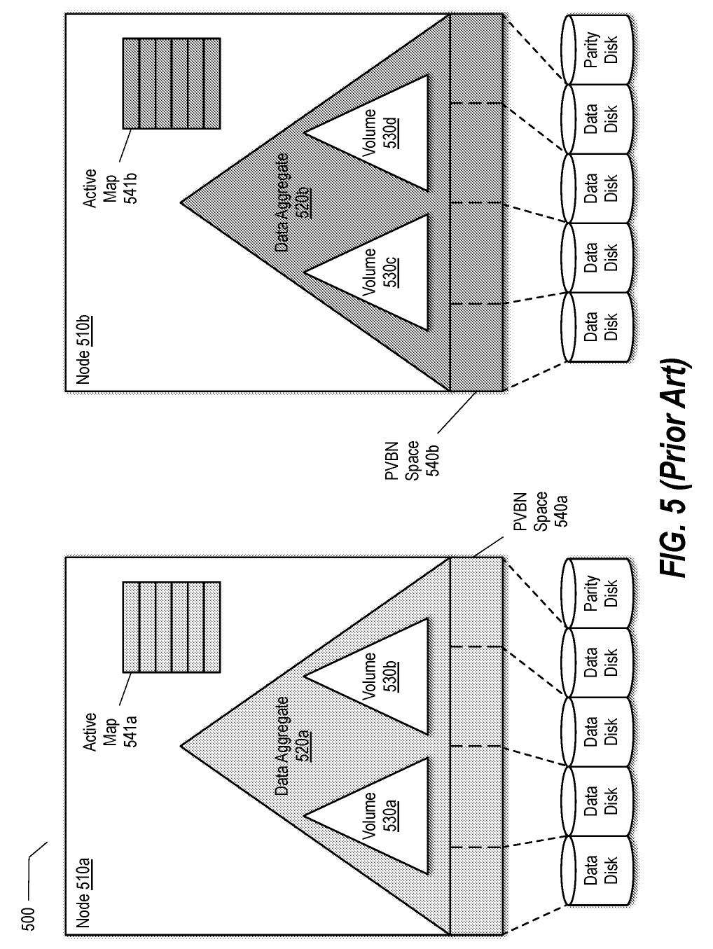

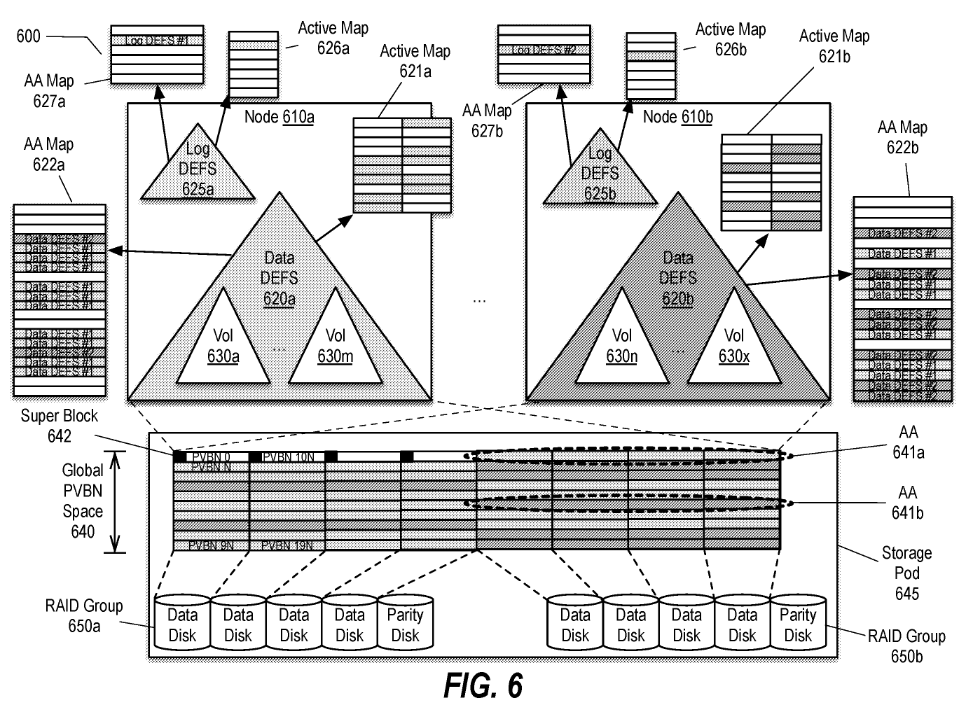

In various examples described herein, storage device (or “disk” which is used interchangeably through this specification) space may be used more fluidly across all the individual storage systems (e.g., nodes) of a distributed storage system (e.g., a cluster of nodes working together), thereby eliminating silos of storage; and processing resource (e.g., central processing unit (CPU)) load may be distributed across the cluster. The proposed architecture seeks to prevent a given disk from being tied to any single node of the cluster by making use of dynamically extensible file systems, examples of which are described further below with reference to FIG. 6. In contrast to the entirety of a given storage device (e.g., a disk) being owned by a node-level aggregate and the aggregate file system being visible from only one node of a cluster as shown and described with reference to FIG. 5, the use of dynamically extensible file systems facilitates visibility by all nodes in the cluster to the entirety of a global physical volume block number (PVBN) space of the disks associated with a single storage pod that may be shared by all of the nodes of the cluster with space from the global PVBN space being used on demand.

In one embodiment, each node of a cluster has access to do read and write to all the disks in a storage pod associated with the cluster. Given all the nodes have access to the same disks, a RAID subsystem or layer can now assimilate the same RAID tree from the same set of disks and present the global PVBN space to the file system (e.g., a write anywhere file system, such as the write anywhere file layout (WAFL) file system available from NetApp, Inc. of San Jose, CA). Using the global PVBN space, each node of the cluster can create an independent file system that it needs. As those skilled in the art will appreciate, it would be dangerous for each node to allocate from the same global PVBN space independently and without limitation. As such, examples of the proposed architecture restrict each dynamically extensible file system to use (consume) space only from the blocks assigned to (owned by) it. As such, when performing writes, each dynamically extensible file system stays in its own lane without the need for complex access control mechanisms, such as locks.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider or hyperscaler (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein, a “storage system” or “storage appliance” generally refers to a type of computing appliance or node, in virtual or physical form, that provides data to, or manages data for, other computing devices or clients (e.g., applications). The storage system may be part of a cluster of multiple nodes representing a distributed storage system. In various examples described herein, a storage system may be run (e.g., on a VM or as a containerized instance, as the case may be) within a public cloud provider.

As used herein, the term “storage operating system” generally refers to computer-executable code operable on a computer to perform a storage function that manages data access and may, in the case of a storage system (e.g., a node), implement data access semantics of a general purpose operating system. The storage operating system can also be implemented as a microkernel, an application program operating over a general-purpose operating system, such as UNIX or Windows NT, or as a general-purpose operating system with configurable functionality, which is configured for storage applications as described herein. In some embodiments, a light-weight data adaptor may be deployed on one or more server or compute nodes added to a cluster to allow compute-intensive data services to be performed without adversely impacting performance of storage operations being performed by other nodes of the cluster. The light-weight data adaptor may be created based on a storage operating system but, since the server node will not participate in handling storage operations on behalf of clients, the light-weight data adaptor may exclude various subsystems/modules that are used solely for serving storage requests and that are unnecessary for performance of data services. In this manner, compute intensive data services may be handled within the cluster by one of more dedicated compute nodes.

As used herein, a “cloud volume” generally refers to persistent storage that is accessible to a virtual storage system by virtue of the persistent storage being associated with a compute instance in which the virtual storage system is running. A cloud volume may represent a hard-disk drive (HDD) or a solid-state drive (SSD) from a pool of storage devices within a cloud environment that is connected to the compute instance through Ethernet or fibre channel (FC) switches as is the case for network-attached storage (NAS) or a storage area network (SAN). Non-limiting examples of cloud volumes include various types of SSD volumes (e.g., AWS Elastic Block Store (EBS) gp2, gp3, io1, and io2 volumes for EC2 instances) and various types of HDD volumes (e.g., AWS EBS st1 and sc1 volumes for EC2 instances).

As used herein a “consistency point” or “CP” generally refers to the act of writing data to disk and updating active file system pointers. In various examples, when a file system of a storage system receives a write request, it commits the data to permanent storage before the request is confirmed to the writer. Otherwise, if the storage system were to experience a failure with data only in volatile memory, that data would be lost, and underlying file structures could become corrupted. Physical storage appliances commonly use battery-backed high-speed non-volatile random access memory (NVRAM) as a journaling storage media to journal writes and accelerate write performance while providing permanence, because writing to memory is much faster than writing to storage (e.g., disk). Storage systems may also implement a buffer cache in the form of an in-memory cache to cache data that is read from data storage media (e.g., local mass storage devices or a storage array associated with the storage system) as well as data modified by write requests. In this manner, in the event a subsequent access relates to data residing within the buffer cache, the data can be served from local, high performance, low latency storage, thereby improving overall performance of the storage system. Virtual storage appliances may use NV storage backed by cloud volumes in place of NVRAM for journaling storage and for the buffer cache. Regardless of whether NVRAM or NV storage is utilized, the modified data may be periodically (e.g., every few seconds) flushed to the data storage media. As the buffer cache may be limited in size, an additional cache level may be provided by a victim cache, typically implemented within a slower memory or storage device than utilized by the buffer cache, that stores data evicted from the buffer cache. The event of saving the modified data to the mass storage devices may be referred to as a CP. At a CP, the file system may save any data that was modified by write requests to persistent data storage media. As will be appreciated, when using a buffer cache, there is a small risk of a system failure occurring between CPs, causing the loss of data modified after the last CP. Consequently, the storage system may maintain an operation log or journal of certain storage operations within the journaling storage media that have been performed since the last CP. This log may include a separate journal entry (e.g., including an operation header) for each storage request received from a client that results in a modification to the file system or data. Such entries for a given file may include, for example, “Create File,” “Write File Data,” and the like. Depending upon the operating mode or configuration of the storage system, each journal entry may also include the data to be written according to the corresponding request. The journal may be used in the event of a failure to recover data that would otherwise be lost. For example, in the event of a failure, it may be possible to replay the journal to reconstruct the current state of stored data just prior to the failure. As described further below, in various examples there may be one or more predefined or configurable triggers (CP triggers). Responsive to a given CP trigger (or at a CP), the file system may save any data that was modified by write requests to persistent data storage media.

As used herein, a “RAID stripe” generally refers to a set of blocks spread across multiple storage devices (e.g., disks of a disk array, disks of a disk shelf, or cloud volumes) to form a parity group (or RAID group).

As used herein, an “allocation area” or “AA” generally refers to a group of RAID stripes. In various examples described herein a single storage pod may be shared by a distributed storage system by assigning ownership of AAs to respective dynamically extensible file systems of a storage system.

As used herein, a “free allocation area” or “free AA” generally refers to an AA in which no PVBNs of the AA are marked as used, for example, by any active maps of a given dynamically extensible file system.

As used herein, a “partial allocation area” or “partial AA” generally refers to an AA in which one or more PVBNs of the AA are marked as in use (containing valid data), for example, by an active map of a given dynamically extensible file system. As discussed further below, in connection with space balancing, while it is preferable to perform AA ownership changes of free AAs, in various examples, space balancing may involve one dynamically extensible file system donating one or more partial AAs to another dynamically extensible file system. In such cases, the additional cost of copying portions of one or more associated data structures (e.g., bit maps, such as an active map, a refcount map, a summary map, an AA information map, and a space map) relating to storage space information may be incurred. No such additional cost is incurred when moving or changing ownership of free AAs. These associated data structures may, among other things, track which PVBNs are in use, track PVBN counts per AA (e.g., total used blocks and shared references to blocks) and other flags.

As used herein, a “storage pod” generally refers to a group of disks containing multiple RAID groups that are accessible from all storage systems (nodes) of a distributed storage system (cluster).

As used herein, a “data pod” generally refers to a set of storage systems (nodes) that share the same storage pod. In some examples, a data pod refers to a single cluster of nodes representing a distributed storage system. In other examples, there can be multiple data pods in a cluster. Data pods may be used to limit the fault domain and there can be multiple HA pairs of nodes within a data pod.

As used herein, an “active map” is a data structure that contains information indicative of which PVBNs of a distributed file system are in use. In one embodiment, the active map is represented in the form of a sparce bit map in which each PVBN of a global PVBN space of a storage pod has a corresponding Boolean value (or truth value) represented as a single bit, for example, in which the true (1) indicates the corresponding PVBN is in use and false (0) indicates the corresponding PVBN is not in use.

As used herein, a “dynamically extensible file system” or a “DEFS” generally refers to a file system of a data pod or a cluster that has visibility into the entire global PVBN space of a storage pod and hosts multiple volumes. A DEFS may be thought of as a data container or a storage container (which may be referred to as a storage segment container) to which AAs are assigned, thereby resulting in a more flexible and enhanced version of a node-level aggregate. As described further herein (for example, in connection with automatic space balancing), the storage space associated with one or more AAs of a given DEFS may be dynamically transferred or moved on demand to any other DEFS in the cluster by changing the ownership of the one or more AAs and moving associated AA tracking data structures as appropriate. This provides the unique ability to independently scale each DEFS of a cluster. For example, DEFSs can shrink or grow dynamically over time to meet their respective storage needs and silos of storage space are avoided. In one embodiment, a distributed file system comprises multiple instances of the WAFL Copy-on-Write file system running on respective storage systems (nodes) of a distributed storage system (cluster) that represents the data pod. In various examples described herein, a given storage system (node) of a distributed storage system (cluster) may own one or more DEFSs including, for example, a log DEFS for hosting an operation log or journal of certain storage operations that have been performed by the node since the last CP and a data DEFS for hosting customer volumes or logical unit numbers (LUNs). As described further below, the partitioning/division of a storage pod into AAs (creation of a disaggregated storage space) and the distribution of ownership of AAs among DEFSs of multiple nodes of a cluster may facilitate implementation of a distributed storage system having a disaggregated storage architecture. In various examples described herein, each storage system may have its own portion of disaggregated storage to which it has the exclusive ability to perform write access, thereby simplifying storage management by, among otherings, not requiring implementation of access control mechanisms, for example, in the form of locks. At the same time, each storage system also has visibility into the entirety of a global PVBN space, thereby allowing read access by a given storage system to any portion of the disaggregated storage regardless of which node of the cluster is the current owner of the underlying allocation areas. Based disclosure provided herein, those skilled in the art will understand there are at least two types of disaggregation represented/achieved within various examples, including (i) the disaggregation of storage space provided by a storage pod by dividing or partitioning the storage space into AAs the ownership of which can be fluidly changed from one DEFS to another on demand and (ii) the disaggregation of the storage architecture into independent components, including the decoupling of processing resources and storage resources, thereby allowing them to be independently scaled. In one embodiment, the former (which may also be referred to as modular storage, partitioned storage, adaptable storage, or fluid storage) facilitates the latter.

As used herein, an “allocation area map” or “AA map” generally refers to a per dynamically extensible file system data structure or file (e.g., a metafile) that contains information at an AA-level of granularity indicative of which AAs are assigned to or “owned” by a given dynamically extensible file system.

A “node-level aggregate” generally refers to a file system of a single storage system (node) that holds multiple volumes created over one or more RAID groups, in which the node owns the entire PVBN space of the collection of disks of the one or more RAID groups. Node-level aggregates are only accessible from a single storage system (node) of a distributed storage system (cluster) at a time.

As used herein, an “inode” generally refers to a file data structure maintained by a file system that stores metadata for data containers (e.g., directories, subdirectories, disk files, etc.). An inode may include, among other things, location, file size, permissions needed to access a given file with which it is associated as well as creation, read, and write timestamps, and one or more flags.

As used herein, a “storage volume” or “volume” generally refers to a container or logical storage unit, for example, in which applications, databases, and file systems store data. A volume is a logical component that may be created for the host to access storage on a storage array. A volume may be created from the capacity available in a storage pod, a pool, or a volume group. A volume has a defined capacity. Although a volume might consist of more than one storage device (e.g., drive), a volume appears as one logical component to the host. Non-limiting examples of a volume include a flexible volume and a flexgroup volume.

As used herein, a “flexible volume” generally refers to a type of storage volume that may be efficiently distributed across multiple storage devices. A flexible volume may be capable of being resized to meet changing business or application requirements. In some embodiments, a storage system may provide one or more aggregates and one or more storage volumes distributed across a plurality of nodes interconnected as a cluster. Each of the storage volumes may be configured to store data such as files and logical units. As such, in some embodiments, a flexible volume may be comprised within a storage aggregate and further comprises at least one storage device. The storage aggregate may be abstracted over a RAID plex where each plex comprises a RAID group. Moreover, each RAID group may comprise a plurality of storage disks. As such, a flexible volume may comprise data storage spread over multiple storage disks or devices. A flexible volume may be loosely coupled to its containing aggregate. A flexible volume can share its containing aggregate with other flexible volumes. Thus, a single aggregate can be the shared source of all the storage used by all the flexible volumes contained by that aggregate. A non-limiting example of a flexible volume is a NetApp ONTAP FlexVol volume.

As used herein, a “flexgroup volume” generally refers to a single namespace that is made up of multiple constituent/member volumes. A non-limiting example of a flexgroup volume is a NetApp ONTAP FlexGroup volume that can be managed by storage administrators, and which acts like a NetApp FlexVol volume. In the context of a flexgroup volume, “constituent volume” and “member volume” are interchangeable terms that refer to the underlying volumes (e.g., flexible volumes) that make up the flexgroup volume.

As used herein, a “volume clone,” a “clone volume” or simply a “clone” generally refers to a readable/writable, space-efficient, point-in-time copy of a parent volume. Clones are space-efficient because they share the same data blocks with their parent volumes for common data. A clone may be created from a backing snapshot copy of a parent volume. The snapshot copy used to create a clone may also be shared with the parent volume.

As used herein, a “remote volume clone,” a “remote clone volume” or simply a “remote clone” generally refers to a clone on a different node of the cluster from that of the parent volume. Notably, in various embodiments described herein, a remote clone may be created without copying the underlying volume data of the parent volume. For example, the volume data may be maintained in place within a storage pod and need not be copied between nodes as part of the remote volume cloning process. Rather, as described further below, only metadata (e.g., the block content of an index node (inode) of a container file representing the given volume) and desired property information (e.g., volume property metafiles) associated with the given volume may be copied from the parent (source) node to the child (destination) node. Depending on the particular implementation, volume properties may include information related to, among other things, a fingerprint database containing fingerprints used for deduplication within the volume, Storage Area Network (SAN) files, and files subject to compliance protections. As those skilled in the art will appreciate, a zero-copy remote volume cloning approach can be performed as a constant-time operation that is independent of the amount of data stored within the volume at issue.

As used herein a “backing snapshot copy,” a “backing snapshot” or simply a “snapshot” generally refers to a container representing a point-in-time image of a dataset (e.g., a volume) containing metadata (e.g., that points to or otherwise identifies the underlying data) instead of including a copy of the underlying data. A non-limiting example of a snapshot is a NetApp snapshot copy. A snapshot may represent a read-only, point-in-time image that consumes minimal storage space and incurs negligible performance overhead. In some examples, the creation of a snapshot is supported by the unique features of a Write Anywhere File Layout (WAFL) file system (available from NetApp, Inc. of San Jose, CA), which makes possible low-overhead snapshots that contain metadata (e.g., pointers to data) instead of a copy of the underlying data. For example, the WAFL file system makes use of pointers to actual data blocks on storage devices (e.g., disks) and when data is updated, it does not rewrite existing blocks, but rather the updated data is stored in a new block and the pointer is updated.

As used herein, “locking a snapshot,” generally refers to making the snapshot tamper-proof by rendering it immutable, or indelible, for a specified retention period. According to some examples, locking a snapshot prevents deletion by

***Further discussion regarding creation and retention of immutable snapshots in the context of providing ransomware protection is provided by US Patent Application No. 18/168,739, which is hereby incorporated by reference in its entirety for all purposes.

As used herein, a “super block” or “superblock” generally refers to a fundamental file system metadata structure that contains information about the file system’s layout, size, status, and other metadata that may be used by the file system to manage and access data. For example, a super block may act as a high-level map for the file system (e.g., a given DEFS), defining its characteristics and organizing its data structures. The super blocks described herein may be analogous to superblocks used in other file systems. In various examples described herein, super blocks may be used to store metadata about files and/or volumes. For example, a super block may contain information about the volumes hosted by a DEFS, thereby acting as a control block for the operation and organization of the DEFS. As noted below, the file system may cause multiple redundant copies of super blocks to be stored (within the file system or outside of the file system) for data protection and to ensure file system availability.

As used herein, “metadata read cache technology” generally refers to a metadata caching mechanism in which a remote view of metadata (e.g., metafiles) of one file system (e.g., a DEFS of a first node of a storage cluster) is made available to another file system (e.g., another DEFS of the same or a different node of the storage cluster).

As used herein, a “context mismatch” generally refers to a mismatch between context data associated with a data block that has been read as compared to the expected context data. Many storage systems store a checksum value with each data block (e.g., a count of the number of set bits in the data block). In this manner, when reading the data block, the checksum may be confirmed to ensure that the data block was read correctly, for example, by comparing a newly computed checksum based on the read data against the stored checksum. Furthermore, certain storage systems are configured to store context information (or “context data”) with each data block in addition to the checksum. For instance, certain storage file systems (e.g., the Write Anywhere File Layout (WAFL®) file system (available from NetApp, Inc. of San Jose, CA)) may implement various techniques to point to physical storage locations for data block access. As such, while the checksum may be used to confirm that the data within a stored data block was read correctly, performing a “context check” based on the context data (e.g., represented by a tuple including a buffer tree identifier (ID) (which may also be referred to herein as a “bufftree ID”), a data ID or file block number (FBN), and information indicative of a relative write time of the data at issue) may be used to confirm that the data block accessed is the correct data block. As will be appreciated by those skilled in the art, one scenario in which the data block accessed may not be the correct data block includes a situation in which the data block has been moved (“reallocated”) to a new physical location (e.g., to defragment the storage space). As discussed further below, in such a scenario a remote clone volume may be refreshed and/or perform a remote container resolution workflow.

### EXAMPLE DISTRIBUTED STORAGE SYSTEM CLUSTER

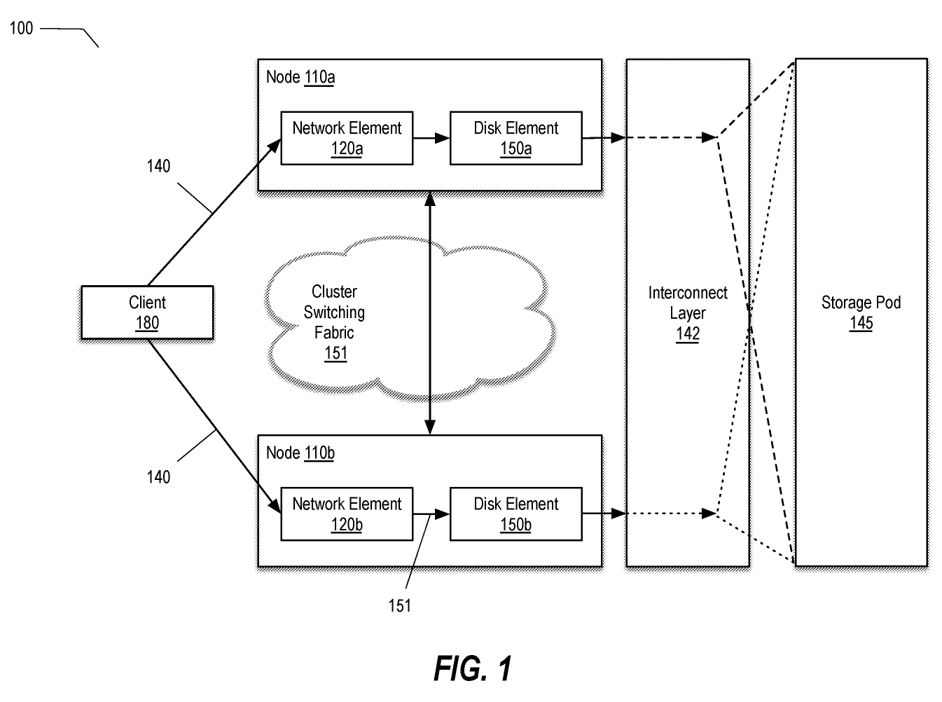

FIG. 1 is a block diagram illustrating a plurality of nodes 110a-b interconnected as a cluster 100 in accordance with an embodiment of the present disclosure. In the context of the present example, the nodes 110a-b comprise various functional components that cooperate to provide a distributed storage system architecture of the cluster 100. To that end, in the context of the present example, each node is generally organized as a network element (e.g., network element 120a or 120b) and a disk element (e.g., disk element 150a or 150b). The network element includes functionality that enables the node to connect to clients (e.g., client 180) over a computer network 140, while each disk element 350 connects to one or more storage devices, such as disks, of one or more disk arrays (not shown) or of one or more storage shelves (not shown), represented as a single shared storage pod 145.

In the context of the present example, the nodes 110a-b are interconnected by a cluster switching fabric 151 which, in an example, may be embodied as a Gigabit Ethernet switch. It should be noted that while there is shown an equal number of network and disk elements in the illustrative cluster 100, there may be differing numbers of network and/or disk elements. For example, there may be a plurality of network elements and/or disk elements interconnected in a cluster configuration 100 that does not reflect a one-to-one correspondence between the network and disk elements. As such, the description of a node comprising one network element and one disk element should be taken as illustrative only.

Clients may be general-purpose computers configured to interact with the node in accordance with a client/server model of information delivery. That is, each client (e.g., client 180) may request the services of the node, and the node may return the results of the services requested by the client, by exchanging packets over the network 140. The client may issue packets including file-based access protocols, such as the Common Internet File System (CIFS) protocol or Network File System (NFS) protocol, over the Transmission Control Protocol/Internet Protocol (TCP/IP) when accessing information in the form of files and directories. Alternatively, the client may issue packets including block-based access protocols, such as the Small Computer Systems Interface (SCSI) protocol encapsulated over TCP (iSCSI) and SCSI encapsulated over Fibre Channel (FCP), when accessing information in the form of blocks. In various examples described herein, an administrative user (not shown) of the client may make use of a user interface (UI) presented by the cluster or a command line interface (CLI) of the cluster to, among other things, establish a data protection relationship between a source volume and a destination volume (e.g., a mirroring relationship specifying one or more policies associated with creation, retention, and transfer of snapshots), defining snapshot and/or backup policies, and association of snapshot policies with snapshots.

Disk elements 150a and 150b are illustratively connected to disks (not shown) within that may be organized into disk arrays within the storage pod 145. Alternatively, storage devices other than disks may be utilized, e.g., flash memory, optical storage, solid state devices, etc. As such, the description of disks should be taken as exemplary only.

In general, various embodiments envision a cluster (e.g., cluster 100) in which every node (e.g., nodes 110a-b) can essentially talk to every storage device (e.g., disk) in the storage pod 145. This is in contrast to the distributed storage system architecture described with reference to FIG. 5. In examples described herein, all nodes (e.g., nodes 110a-b) of the cluster have visibility and read access to an entirety of a global PVBN space of the storage pod 145, for example, via an interconnect layer 142. As described further below, according to one embodiment, the storage within the storage pod 145 is grouped into distinct allocation areas (AAs) than can be assigned to a given dynamically extensible file system (DEFS) of a node to facilitate implementation disaggregated storage. In examples described herein, the AAs assigned to a given DEFS may be said to “own” the assigned AAs and the node owning the given DEFS has the exclusive write access to the associated PVBNs and the exclusive ability to perform write allocation from such blocks. In one embodiment, each node has its own view of a portion of the disaggregated storage represented by the assignment of, for example, via respective allocation area (AA) maps and active maps. This granular assignment of AAs and ability to fluidly change ownership of AAs as needed facilitates the elimination of per-node storage silos and provides higher and more predictable performance, which further translate into improved storage utilization and improvements in cost effectiveness of the storage solution.

Depending on the particular implementation, the interconnect layer 142 may be represented by an intermediate switching topology or some other interconnectivity layer or disk switching layer between the disks in the storage pod 145 and the nodes. Non-limiting examples of the interconnect layer 150 include one or more fiber channel switches or one or more non-volatile memory express (NVMe) fabric switches. Additional details regarding the storage pod 145, DEFSs, AA maps, active maps, and the use, ownership, and sharing (transferring of ownership) of AAs are described further below.

### EXAMPLE STORAGE SYSTEM NODE

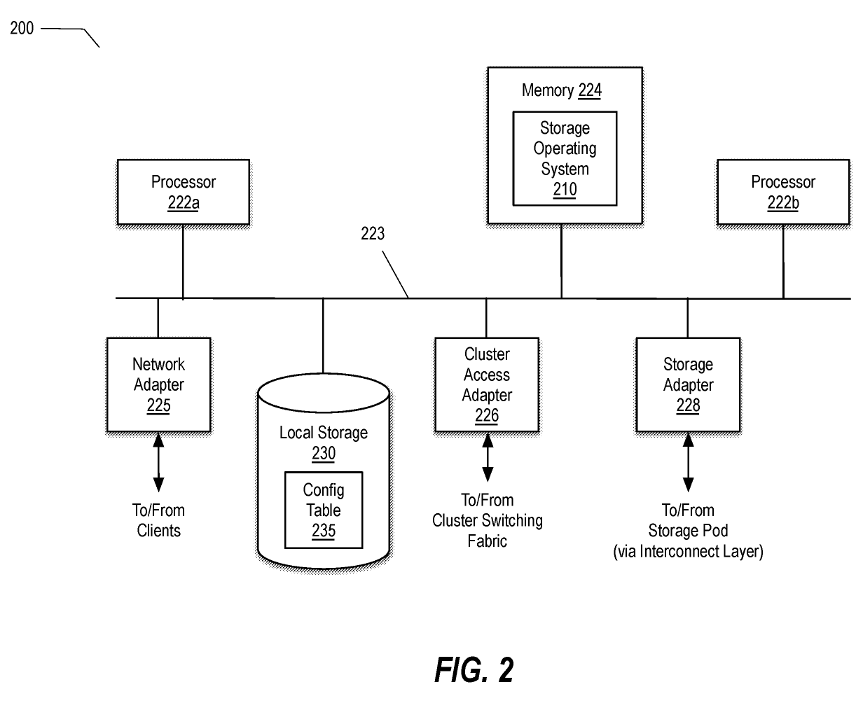

FIG. 2 is a block diagram of a node 200 that is illustratively embodied as a storage system comprising a plurality of processors (e.g., processors 222a-b), a memory 224, a network adapter 225, a cluster access adapter 226, a storage adapter 228 and local storage 230 interconnected by a system bus 223. Node 200 may be analogous to nodes 110a and 110b of FIG. 1. The local storage 230 comprises one or more storage devices, such as disks, utilized by the node to locally store configuration information (e.g., in configuration table 235). The cluster access adapter 226 comprises a plurality of ports adapted to couple the node 200 to other nodes of the cluster (e.g., cluster 100). Illustratively, Ethernet is used as the clustering protocol and interconnect media, although it will be apparent to those skilled in the art that other types of protocols and interconnects may be utilized within the cluster architecture described herein. Alternatively, where the network elements and disk elements are implemented on separate storage systems or computers, the cluster access adapter 226 is utilized by the network and disk element for communicating with other network and disk elements in the cluster.

In the context of the present example, each node 200 is illustratively embodied as a dual processor storage system executing a storage operating system 210 that implements a high-level module, such as a file system, to logically organize the information as a hierarchical structure of named directories, files and special types of files called virtual disks (hereinafter generally “blocks”) on the disks. However, it will be apparent to those of ordinary skill in the art that the node 200 may alternatively comprise a single or more than two processor system. Illustratively, one processor (e.g., processor 222a) may execute the functions of the network element (e.g., network element 120a or 120b) on the node, while the other processor (e.g., processor 222b) may execute the functions of the disk element (e.g., disk element 150a or 150b).

The memory 224 illustratively comprises storage locations that are addressable by the processors and adapters for storing software program code and data structures associated with the subject matter of the disclosure. The processor and adapters may, in turn, comprise processing elements and/or logic circuitry configured to execute the software code and manipulate the data structures. The storage operating system 210, portions of which is typically resident in memory and executed by the processing elements, functionally organizes the node 200 by, inter alia, invoking storage operations in support of the storage service implemented by the node. It will be apparent to those skilled in the art that other processing and memory means, including various computer readable media, may be used for storing and executing program instructions pertaining to the disclosure described herein.

The network adapter 225 comprises a plurality of ports adapted to couple the node 200 to one or more clients (e.g., client 180) over point-to-point links, wide area networks, virtual private networks implemented over a public network (Internet) or a shared local area network. The network adapter 225 thus may comprise the mechanical, electrical and signaling circuitry needed to connect the node to a network (e.g., computer network 140). Illustratively, the network may be embodied as an Ethernet network or a Fibre Channel (FC) network. Each client (e.g., client 180) may communicate with the node over network by exchanging discrete frames or packets of data according to pre-defined protocols, such as TCP/IP.

The storage adapter 228 cooperates with the storage operating system 210 executing on the node 200 to access information requested by the clients. The information may be stored on any type of attached array of writable storage device media such as video tape, optical, DVD, magnetic tape, bubble memory, electronic random access memory, micro-electromechanical and any other similar media adapted to store information, including data and parity information. However, as illustratively described herein, the information is stored on disks (e.g., associated with storage pod 145). The storage adapter comprises a plurality of ports having input/output (I/O) interface circuitry that couples to the disks over an I/O interconnect arrangement, such as a conventional high-performance, FC link topology.

Storage of information on each disk array may be implemented as one or more storage “volumes” that comprise a collection of physical storage disks or cloud volumes cooperating to define an overall logical arrangement of volume block number (VBN) space on the volume(s). Each logical volume is generally, although not necessarily, associated with its own file system. The disks within a logical volume/file system are typically organized as one or more groups, wherein each group may be operated as a Redundant Array of Independent (or Inexpensive) Disks (RAID). Most RAID implementations, such as a RAID-4 level implementation, enhance the reliability/integrity of data storage through the redundant writing of data “stripes” across a given number of physical disks in the RAID group, and the appropriate storing of parity information with respect to the striped data. An illustrative example of a RAID implementation is a RAID-4 level implementation, although it should be understood that other types and levels of RAID implementations may be used in accordance with the inventive principles described herein.

While in the context of the present example, the node may be a physical host, it is to be appreciated the node may be implemented in virtual form. For example, a storage system may be run (e.g., on a VM or as a containerized instance, as the case may be) within a public cloud provider. As such, a cluster representing a distributed storage system may be comprised of multiple physical nodes (e.g., node 200) or multiple virtual nodes (virtual storage systems).

### EXAMPLE STORAGE OPERATING SYSTEM

To facilitate access to the disks (e.g., disks within one or more disk arrays of a storage pod, such as storage pod 145 of FIG. 1), a storage operating system (e.g., storage operating system 300, which may be analogous to storage operating system 210) may implement a write-anywhere file system that cooperates with one or more virtualization modules to “virtualize” the storage space provided by disks. The file system logically organizes the information as a hierarchical structure of named directories and files on the disks. Each “on-disk” file may be implemented as set of disk blocks configured to store information, such as data, whereas the directory may be implemented as a specially formatted file in which names and links to other files and directories are stored. The virtualization module(s) allow the file system to further logically organize information as a hierarchical structure of blocks on the disks that are exported as named logical unit numbers (LUNs).

Illustratively, the storage operating system may be the Data ONTAP operating system available from NetApp, Inc., San Jose, Calif. that implements the WAFL file system. However, it is expressly contemplated that any appropriate storage operating system may be enhanced for use in accordance with the inventive principles described herein. As such, where the term “WAFL” is employed, it should be taken broadly to refer to any file system that is otherwise adaptable to the teachings of this disclosure.

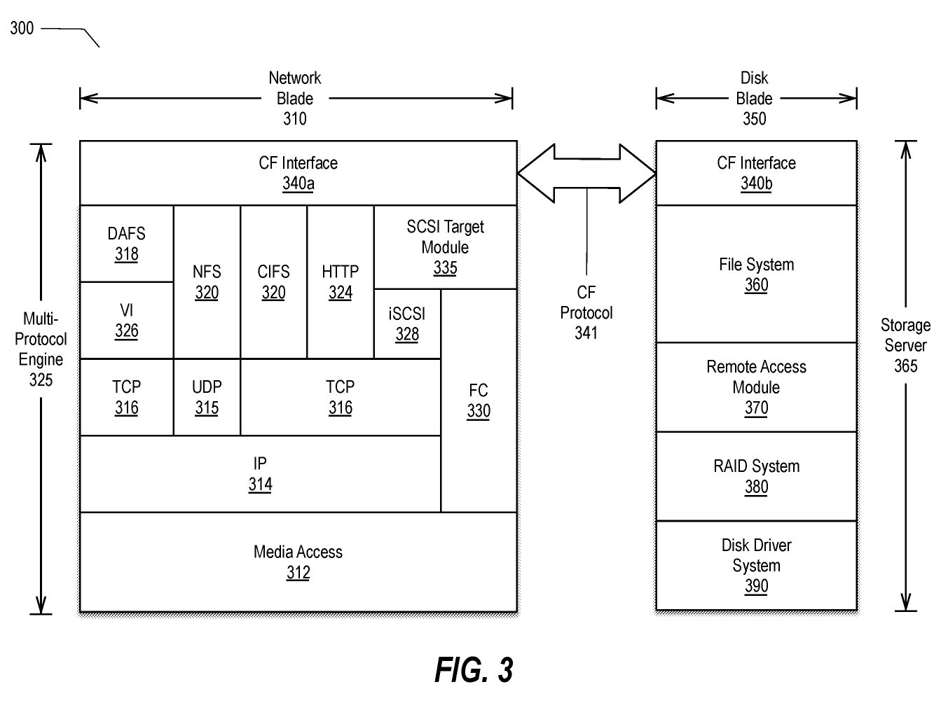

FIG. 3 is a block diagram illustrating a storage operating system 300 in accordance with an embodiment of the present disclosure. In the context of the present example, the storage operating system 300 is shown including a series of software layers organized to form an integrated network protocol stack or, more generally, a multi-protocol engine 325 that provides data paths for clients to access information stored on the node using block and file access protocols. The multi-protocol engine includes a media access layer 312 of network drivers (e.g., gigabit Ethernet drivers) that interfaces to network protocol layers, such as the IP layer 314 and its supporting transport mechanisms, the TCP layer 316 and the User Datagram Protocol (UDP) layer 315. A file system protocol layer provides multi-protocol file access and, to that end, includes support for the Direct Access File System (DAFS) protocol 318, the NFS protocol 320, the CIFS protocol 322 and the Hypertext Transfer Protocol (HTTP) protocol 324. A VI layer 326 implements the VI architecture to provide direct access transport (DAT) capabilities, such as RDMA, as required by the DAFS protocol 318. An iSCSI driver layer 328 provides block protocol access over the TCP/IP network protocol layers, while a FC driver layer 330 receives and transmits block access requests and responses to and from the node. The FC and iSCSI drivers provide FC-specific and iSCSI-specific access control to the blocks and, thus, manage exports of LUNs to either iSCSI or FCP or, alternatively, to both iSCSI and FCP when accessing the blocks on the node (e.g., node 200).

In addition, the storage operating system may include a series of software layers organized to form a storage server 365 that provides data paths for accessing information stored on the disks (e.g., disks 130) of the node. To that end, the storage server 365 includes a file system module 360 in cooperating relation with a remote access module 370, a RAID system module 380 and a disk driver system module 390. The RAID system 380 manages the storage and retrieval of information to and from the volumes/disks in accordance with I/O operations, while the disk driver system 390 implements a disk access protocol such as, e.g., the SCSI protocol.

The file system 360 may implement a virtualization system of the storage operating system 300 through the interaction with one or more virtualization modules illustratively embodied as, for example, a virtual disk (vdisk) module (not shown) and a SCSI target module 335. The SCSI target module 335 is generally disposed between the FC and iSCSI drivers 328, 330 and the file system 360 to provide a translation layer of the virtualization system between the block (LUN) space and the file system space, where LUNs are represented as blocks.

The file system 360 is illustratively a message-based system that provides logical volume management capabilities for use in access to the information stored on the storage devices, such as disks. That is, in addition to providing file system semantics, the file system 360 provides functions normally associated with a volume manager. These functions include (i) aggregation of the disks, (ii) aggregation of storage bandwidth of the disks, and (iii) reliability guarantees, such as mirroring and/or parity (RAID). The file system 360 illustratively implements an exemplary a file system having an on-disk format representation that is block-based using, e.g., 4 kilobyte (KB) blocks and using index nodes (“inodes”) to identify files and file attributes (such as creation time, access permissions, size and block location). The file system uses files to store meta-data describing the layout of its file system; these meta-data files include, among others, an inode file. A file handle, i.e., an identifier that includes an inode number, is used to retrieve an inode from disk.

Broadly stated, all inodes of the write-anywhere file system are organized into the inode file. A file system (fs) info block specifies the layout of information in the file system and includes an inode of a file that includes all other inodes of the file system. Each logical volume (file system) has an fsinfo block that is preferably stored at a fixed location within, e.g., a RAID group. The inode of the inode file may directly reference (point to) data blocks of the inode file or may reference indirect blocks of the inode file that, in turn, reference data blocks of the inode file. Within each data block of the inode file are embedded inodes, each of which may reference indirect blocks that, in turn, reference data blocks of a file.

Operationally, a request from a client (e.g., client 180) is forwarded as a packet over a computer network (e.g., computer network 140) and onto a node (e.g., node 200) where it is received at a network adapter (e.g., network adaptor 225). A network driver (of layer 312 or layer 330) processes the packet and, if appropriate, passes it on to a network protocol and file access layer for additional processing prior to forwarding to the write-anywhere file system 360. Here, the file system generates operations to load (retrieve) the requested data from disk 130 if it is not resident “in core”, i.e., in memory 224. If the information is not in memory, the file system 360 indexes into the inode file using the inode number to access an appropriate entry and retrieve a logical VBN. The file system then passes a message structure including the logical VBN to the RAID system 380; the logical VBN is mapped to a disk identifier and disk block number (disk,dbn) and sent to an appropriate driver (e.g., SCSI) of the disk driver system 390. The disk driver accesses the dbn from the specified disk 130 and loads the requested data block(s) in memory for processing by the node. Upon completion of the request, the node (and operating system) returns a reply to the client 180 over the network 140.

The remote access module 370 is operatively interfaced between the file system module 360 and the RAID system module 380. Remote access module 370 is illustratively configured as part of the file system to implement the functionality to determine whether a newly created data container, such as a subdirectory, should be stored locally or remotely. Alternatively, the remote access module 370 may be separate from the file system. As such, the description of the remote access module being part of the file system should be taken as exemplary only. Further, the remote access module 370 determines which remote flexible volume should store a new subdirectory if a determination is made that the subdirectory is to be stored remotely. More generally, the remote access module 370 implements the heuristics algorithms used for the adaptive data placement. However, it should be noted that the use of a remote access module should be taken as illustrative. In alternative aspects, the functionality may be integrated into the file system or other module of the storage operating system. As such, the description of the remote access module 370 performing certain functions should be taken as exemplary only.

It should be noted that the software “path” through the storage operating system layers described above needed to perform data storage access for the client request received at the node may alternatively be implemented in hardware. That is, a storage access request data path may be implemented as logic circuitry embodied within a field programmable gate array (FPGA) or an application specific integrated circuit (ASIC). This type of hardware implementation increases the performance of the storage service provided by node 200 in response to a request issued by client 180. Alternatively, the processing elements of adapters 225, 228 may be configured to offload some or all of the packet processing and storage access operations, respectively, from processor 222, to thereby increase the performance of the storage service provided by the node. It is expressly contemplated that the various processes, architectures and procedures described herein can be implemented in hardware, firmware or software.

As used herein, the term “storage operating system” generally refers to the computer-executable code operable on a computer to perform a storage function that manages data access and may, in the case of a node (e.g., node 200), implement data access semantics of a general purpose operating system. The storage operating system can also be implemented as a microkernel, an application program operating over a general-purpose operating system, such as UNIX or Windows NT, or as a general-purpose operating system with configurable functionality, which is configured for storage applications as described herein.

In addition, it will be understood to those skilled in the art that aspects of the disclosure described herein may apply to any type of special-purpose (e.g., file server, filer or storage serving appliance) or general-purpose computer, including a standalone computer or portion thereof, embodied as or including a storage system. Moreover, the teachings contained herein can be adapted to a variety of storage system architectures including, but not limited to, a network-attached storage environment, a storage area network and disk assembly directly attached to a client or host computer. The term “storage system” should therefore be taken broadly to include such arrangements in addition to any subsystems configured to perform a storage function and associated with other equipment or systems. It should be noted that while this description is written in terms of a write anywhere file system, the teachings of the subject matter may be utilized with any suitable file system, including a write in place file system.

### EXAMPLE CLUSTER FABRIC (CF) PROTOCOL

Illustratively, the storage server 365 is embodied as disk element (or disk blade 350, which may be analogous to disk element 150a or 150b) of the storage operating system 300 to service one or more volumes of array 160. In addition, the multi-protocol engine 325 is embodied as network element (or network blade 310, which may be analogous to network element 120a or 120b) to (i) perform protocol termination with respect to a client issuing incoming data access request packets over the network (e.g., network 140), as well as (ii) redirect those data access requests to any storage server 365 of the cluster (e.g., cluster 100). Moreover, the network element 310 and disk element 350 cooperate to provide a highly scalable, distributed storage system architecture of the cluster. To that end, each module may include a cluster fabric (CF) interface module (e.g., CF interface 340a and 340b) adapted to implement intra-cluster communication among the nodes (e.g., node 110a and 110b). In the context of a distributed storage architecture as described below with reference to FIG. 5 in which node-level aggregates are employed, the CF protocol facilitates, among other things, internode communications relating to data access requests. It is to be appreciated such internode communications relating to data access requests are not needed in the context of a distributed storage architecture as described below with reference to FIG. 6 in which each node of a cluster has visibility and access to the entirety of a global PVBN space of a storage pod (via their respective DEFSs). However, in various embodiments, some limited amount of internode communications, for example, relating to storage space reporting (or simply space reporting) and storage space requests (e.g., requests for donations of AAs) continue to be useful. As described further below, such internode communications may make use of the CF protocol or other forms of internode communications, including message passing via on-wire communications and/or the use of one or more persistent message queues (or on-disk message queues), which may make use of the fact that all nodes can read from all disk of a storage pod. For example, a persistent message queue may be maintained at the node and/or DEFS-level of granularity in which each node and/or DEFS has a message queue to which others can post messages destined for the node or DEFS (as the case may be). In one embodiment, each DEFS has an associated inbound queue on which it receives messages sent by another DEFS in the cluster and an associated outbound queue on which it posts messages intended for delivery to another DEFS in the cluster

The protocol layers, e.g., the NFS/CIFS layers and the iSCSI/IFC layers, of the network element 310 may function as protocol servers that translate file-based and block based data access requests from clients into CF protocol messages used for communication with the disk element 350. That is, the network element servers may convert the incoming data access requests into file system primitive operations (commands) that are embedded within CF messages by the CF interface module 340 for transmission to the disk elements of the cluster.

Further, in an illustrative aspect of the disclosure, the network element and disk element are implemented as separately scheduled processes of storage operating system 300; however, in an alternate aspect, the modules may be implemented as pieces of code within a single operating system process. Communication between a network element and disk element may thus illustratively be effected through the use of message passing between the modules although, in the case of remote communication between a network element and disk element of different nodes, such message passing occurs over a cluster switching fabric (e.g., cluster switching fabric 151). A known message-passing mechanism provided by the storage operating system to transfer information between modules (processes) is the Inter Process Communication (IPC) mechanism. The protocol used with the IPC mechanism is illustratively a generic file and/or block-based “agnostic” CF protocol that comprises a collection of methods/functions constituting a CF application programming interface (API). Examples of such an agnostic protocol are the SpinFS and SpinNP protocols available from NetApp, Inc.

The CF interface module 340 implements the CF protocol for communicating file system commands among the nodes or modules of cluster. Communication may be illustratively effected by the disk element exposing the CF API to which a network element (or another disk element) issues calls. To that end, the CF interface module 340 may be organized as a CF encoder and CF decoder. The CF encoder of, e.g., CF interface 340a on network element 310 encapsulates a CF message as (i) a local procedure call (LPC) when communicating a file system command to a disk element 350 residing on the same node 200 or (ii) a remote procedure call (RPC) when communicating the command to a disk element residing on a remote node of the cluster 100. In either case, the CF decoder of CF interface 340b on disk element 350 de-encapsulates the CF message and processes the file system command.

Illustratively, the remote access module 370 may utilize CF messages to communicate with remote nodes to collect information relating to remote flexible volumes. A CF message is used for RPC communication over the switching fabric between remote modules of the cluster; however, it should be understood that the term “CF message” may be used generally to refer to LPC and RPC communication between modules of the cluster. The CF message includes a media access layer , an IP layer , a UDP layer , a reliable connection (RC) layer and a CF protocol layer. The CF protocol is a generic file system protocol that may convey file system commands related to operations contained within client requests to access data containers stored on the cluster; the CF protocol layer is that portion of a message that carries the file system commands. Illustratively, the CF protocol is datagram based and, as such, involves transmission of messages or “envelopes” in a reliable manner from a source (e.g., a network element 310) to a destination (e.g., a disk element 350). The RC layer implements a reliable transport protocol that is adapted to process such envelopes in accordance with a connectionless protocol, such as UDP.

### Example File System Layout

In one embodiment, a data container or container file is represented in the write-anywhere file system as an inode data structure adapted for storage on the disks of a storage pod (e.g., storage pod 145). The inode may include a meta-data section and a data section. The information stored in the meta-data section of each inode describes the container file (e.g., a file, a snapshot, etc.) and, as such, may include the type (e.g., regular, directory, vdisk) of file, its size , time stamps (e.g., access and/or modification time) and ownership (e.g., user identifier (UID) and group ID (GID), of the file, and a generation number . The contents of the data section of each inode may be interpreted differently depending upon the type of file (inode) defined within the type field. For example, the data section of a directory inode includes meta-data controlled by the file system, whereas the data section of a regular inode includes file system data. In this latter case, the data section includes a representation of the data associated with the file.

Specifically, the data section of a regular on-disk inode (or disk inode) may include file system data or pointers, the latter referencing 4 KB data blocks on disk used to store the file system data. Each pointer may be a block number (e.g., a logical VBN to facilitate efficiency among the file system and the RAID system when accessing the data on disks). Given the restricted size (e.g., 128 bytes) of the inode, file system data having a size that is less than or equal to 64 bytes is represented, in its entirety, within the data section of that inode. However, if the length of the contents of the data container or container file exceeds 64 bytes but less than or equal to 64 KB, then the data section of the inode (e.g., a first level inode) comprises up to 16 pointers, each of which references a 4 KB block of data on the disk.

Moreover, if the size of the data is greater than 64 KB but less than or equal to 64 megabytes (MB), then each pointer in the data section of the inode (e.g., a second level inode) references an indirect block (e.g., a first level L1 block) that contains 224 pointers, each of which references a 4 KB data block on disk. For file system data having a size greater than 64 MB, each pointer in the data section of the inode (e.g., a third level L3 inode) references a double-indirect block (e.g., a second level L2 block) that contains 224 pointers, each referencing an indirect (e.g., a first level L1) block. The indirect block, in turn, which contains 224 pointers, each of which references a 4 kB data block on disk. When accessing a file, each block of the file may be loaded from disk into memory (e.g., memory 224). In other embodiments, higher levels are also possible that may be used to handle larger data container or container file sizes.

When an on-disk inode (or block) is loaded from disk into memory, its corresponding in-core structure embeds the on-disk structure. The in-core structure is a block of memory that stores the on-disk structure plus additional information needed to manage data in the memory (but not on disk). The additional information may include, e.g., a “dirty” bit. After data in the inode (or block) is updated/modified as instructed by, e.g., a write operation, the modified data is marked “dirty” using the dirty bit so that the inode (block) can be subsequently “flushed” (stored) to disk.

According to one embodiment, a file in a file system comprises a buffer tree that provides an internal representation of blocks for a file loaded into memory and maintained by the write-anywhere file system 360. A root (top-level) buffer, such as the data section embedded in an inode, references indirect (e.g., level 1) blocks. In other embodiments, there may be additional levels of indirect blocks (e.g., level 2, level 3) depending upon the size of the file. The indirect blocks (e.g., and inode) includes pointers that ultimately reference data blocks used to store the actual data of the file. That is, the data of file are contained in data blocks and the locations of these blocks are stored in the indirect blocks of the file. Each level 1 indirect block may include pointers to as many as 224 data blocks. According to the “write anywhere” nature of the file system, these blocks may be located anywhere on the disks.

In one embodiment, a file system layout is provided that apportions an underlying physical volume into one or more virtual volumes (or flexible volumes) of a storage system, such as node 200. Depending on the particular implementation, the underlying physical volume may be a DEFS or an aggregate comprising one or more groups of disks, such as RAID groups. When using a storage pod (e.g., storage pod 145) all DEFSs may share a common global PVBN space. In other examples, the aggregate may have its own physical volume block number (PVBN) space. The DEFS or aggregate, as the case may be, also maintains meta-data, such as block allocation structures, within that PVBN space. Each flexible volume has its own virtual volume block number (VVBN) space and maintains meta-data, such as block allocation structures, within that VVBN space. Each flexible volume is a file system that is associated with a container file; the container file is a file in the DEFS or aggregate that contains all blocks used by the flexible volume. Moreover, each flexible volume comprises data blocks and indirect blocks that contain block pointers that point at either other indirect blocks or data blocks.

In a further embodiment, PVBNs are used as block pointers within buffer trees of files stored in a flexible volume. This “hybrid” flexible volume example involves the insertion of only the PVBN in the parent indirect block (e.g., inode or indirect block). On a read path of a logical volume, a “logical” volume (vol) info block has one or more pointers that reference one or more fsinfo blocks, each of which, in turn, points to an inode file and its corresponding inode buffer tree. The read path on a flexible volume is generally the same, following PVBNs (instead of VVBNs) to find appropriate locations of blocks; in this context, the read path (and corresponding read performance) of a flexible volume is substantially similar to that of a physical volume. Translation from PVBN-to-disk,dbn occurs at the file system/RAID system boundary of the storage operating system 300.

In a dual VBN hybrid flexible volume example, both a PVBN and its corresponding VVBN are inserted in the parent indirect blocks in the buffer tree of a file. That is, the PVBN and VVBN are stored as a pair for each block pointer in most buffer tree structures that have pointers to other blocks, e.g., level 1 (L1) indirect blocks, inode file level 0 (L0) blocks.

A root (top-level) buffer, such as the data section embedded in an inode, references indirect (e.g., level 1) blocks. Note that there may be additional levels of indirect blocks (e.g., level 2, level 3) depending upon the size of the file. The indirect blocks (and inode) include PVBN/VVBN pointer pair structures that ultimately reference data blocks used to store the actual data of the file. The PVBNs reference locations on disks of the aggregate, whereas the VVBNs reference locations within files of the flexible volume. The use of PVBNs as block pointers in the indirect blocks provides efficiencies in the read paths, while the use of VVBN block pointers provides efficient access to required meta-data. That is, when freeing a block of a file, the parent indirect block in the file contains readily available VVBN block pointers, which avoids the latency associated with accessing an owner map to perform PVBN-to-VVBN translations; yet, on the read path, the PVBN is available.

### Example Hierarchical Inode Tree

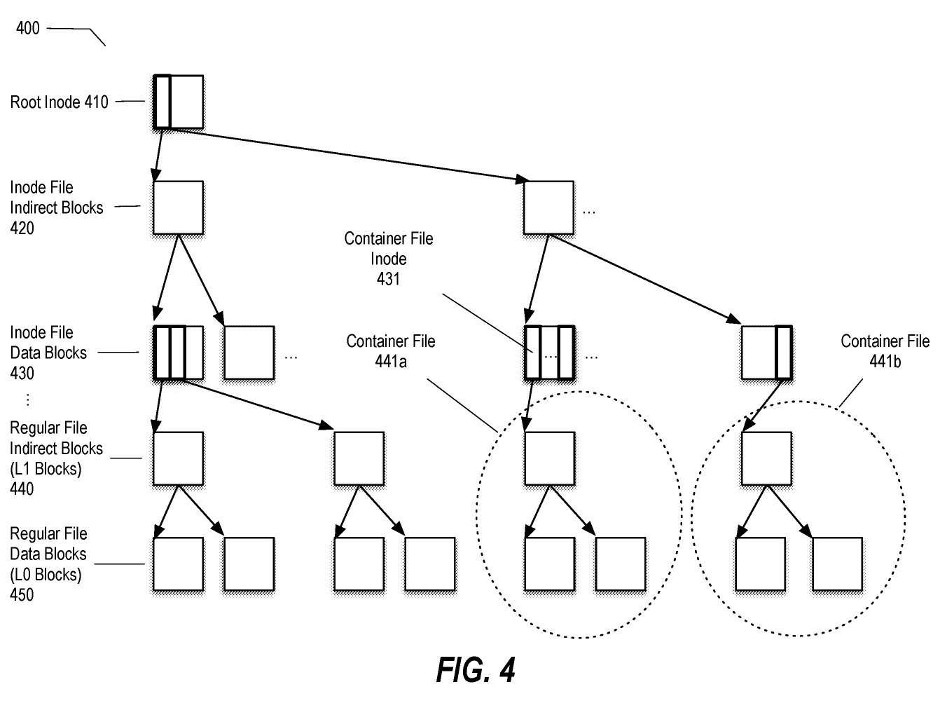

FIG. 4 is a block diagram illustrating a tree of blocks 400 representing a simplified view of an example a file system layout in accordance with an embodiment of the present disclosure. In one embodiment, the data storage system nodes (e.g., data storage systems 110a-b) make use of a write anywhere file system (e.g., the WAFL file system). The write anywhere file system may represent a UNIX compatible file system that is optimized for network file access. In the context of the present example, the write anywhere file system is a block-based file system that represents file system data (e.g., a block map file and an inode map file), meta-data files, and data containers or container files (e.g., volumes, subdirectories, and regular files) in a tree of blocks (e.g., tree of blocks 400). Keeping meta-data in files allows the file system to write meta-data blocks anywhere on disk and makes it easier to increase the size of the file system on the fly.

In this simplified example, the tree of blocks 400 has a root inode 410, which describes an inode map file (not shown), made up of inode file indirect blocks 420 and inode file data blocks 430. The file system may use inodes (e.g., inode file data blocks 430) to describe container files (e.g., container file 441a and container file 441b). In one embodiment, each inode contains 16 block pointers (e.g., PVBNs specifying respective data block locations within the DEFS) to indicate which blocks (e.g., of 4 KB) belong to a given container file (e.g., a volume, a directory, a subdirectory, or a file). Inodes for container files smaller than 64 KB may use the 156 block pointers to point to file data blocks or simply data blocks (e.g., regular file data blocks, which may also be referred to herein as L0 blocks 450). Inodes for files smaller than 64 MB may point to indirect blocks (e.g., regular file indirect blocks, which may also be referred to herein as L1 blocks 440), which point to actual file data. Inodes for larger container files or data containers may point to doubly indirect blocks. For very small files, data may be stored in the inode itself in place of the block pointers. Additional details regarding a specific implementation of a write anywhere file system are provided in US Patent No. 6,239,356, which is incorporated by reference herein in its entirety for all purposes.

As will be appreciated by those skilled in the art given the above-described file system layout, yet another advantage of DEFSs are their ability to facilitate storage space balancing and/or load balancing. This comes from the fact that the entire global PVBN space of a storage pod is visible to all DEFSs of the cluster and therefore any given DEFS can get access to an entire container file by copying the top-most PVBN from the inode on another tree.

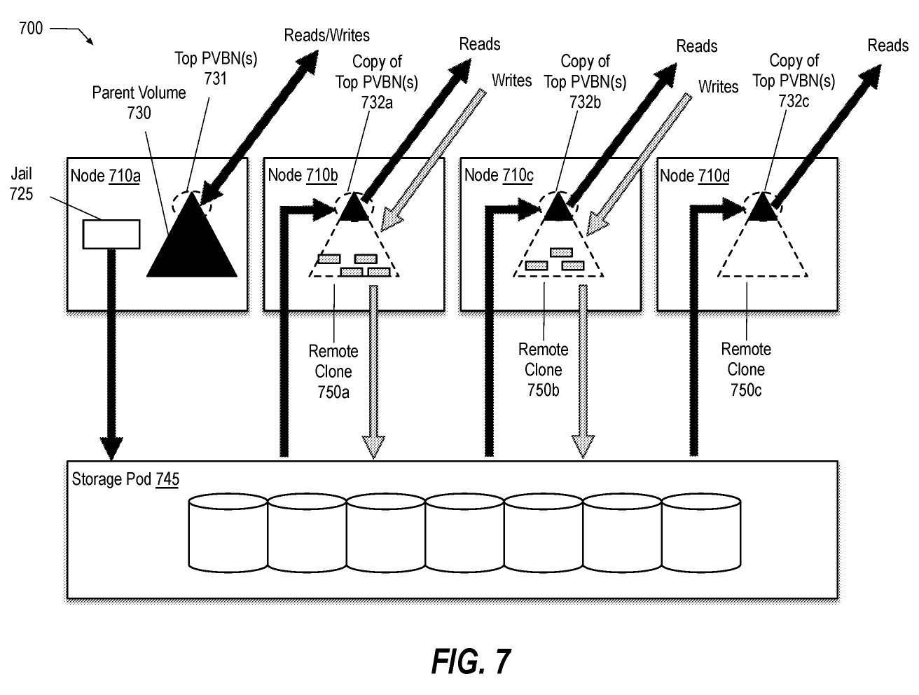

Furthermore, as described herein, with disaggregated storage, DEFSs that are hosted on each node are able to see the entire storage space of a storage pod (e.g., storage pod 145). For example, as described further below with reference to FIGS. 7, this facilitates a new capability of creating a remote clone of a volume (e.g., a container file) of a parent volume in one DEFS of a first node within another DEFS of a second node without copying volume data of the parent volume, for example, by simply copying the disk inode content of the container file inode that hosts the volume to the other DEFS or otherwise caching the top of the WAFL file system tree to the desired remote node(s).

### Example of a Distributed Storage System Architecture with Storage Silos

FIG. 5 is a block diagram illustrating a distributed storage system architecture 500 in which the entirety of a given disk and a given RAID group are owned by an aggregate and the aggregate file system is only visible from one node, thereby resulting in silos of storage space. In the context of FIG. 5, node 510a and node 510b may represent a two-node cluster in which the nodes are high-availability (HA) partners. For example, one node may represent a primary node and the other may represent a secondary node in which pairwise disk connectively supports a pairwise failover model. As shown, each node includes respective active maps (e.g., active map 541a and active map 541b) and a sets of disks (in this case, ten disks) they can talk to. The nodes may partition the disks among themselves as aggregates (e.g., data aggregate 520a and data aggregate 520b) and at steady state both nodes will work on their own subset of disks representing a one or more RAID groups (in this case, four data disks and one parity disk, forming a single RAID group). A RAID layer or subsystem (not shown) of a storage operating system (not shown) of each node may present respective separate and independent PVBN spaces (e.g., PVBN space 540a and PVBN space 540b) to a file system layer (not shown) of the node.

In this example, therefore, data aggregate 520a has visibility only to a first PVBN space (e.g., PVBN space 540a) and data aggregate 520b has visibility only to a second PVBN space (e.g., PVBN space 540b). When data is stored to volume 530a or 530b, it is striped across the subset of disks that are part of data aggregate 520a; and when data is stored to volume 530c or 530d, it is are striped across the subset of disks that are part of data aggregate 520b. Active map 541a is a data structure (e.g., a bit map with one bit per PVBN) that that identifies the PVBNs within PVBN space 540a that are in use by data aggregate 520a. Similarly, active map 541b is a data structure (e.g., a bit map with one bit per PVBN) that that identifies the PVBNs within PVBN space 540b that are in use by data aggregate 520b.

As can be seen, for any given disk, the entire disk is owned by a particular aggregate and the aggregate file system is only visible from one node. Similarly, for any given RAID group, the available storage space of the entire RAID group is useable only by a single node. There are various other disadvantages to the architecture shown in FIG. 5. For example, moving a volume from one aggregate to another requires copying of data (e.g., reading all the blocks used by the volume and writing them to the new location), with an elaborate handover sequence between the aggregates involved. Additionally, there are scenarios in which one data aggregate may run out of storage space while the other still has plentiful free storage space, resulting in ineffective usage of the storage space provided by the disks. While the size of the PVBN space of an aggregate may be increased, doing so typically requires an administrative user to monitor the storage space on each node-level aggregate and add one or more disks and/or RAID groups to the aggregate. As described further below with reference to FIG. 6, with DEFSs storage space is added to a common pool of storage referred to herein as a “storage pod” and space is available for consumption by any DEFS in the cluster, thereby making space management much simpler and facilitating the automatic balancing of storage space without administrator involvement.

### Example Distributed System Architecture Providing Disaggregated Storage

Before getting into the details of a particular example, various properties, constructs, and principles relating to the use and implementation of DEFSs will now be discussed. As noted above, it is desirable to make the global PVBN space of the entire storage pool available on each DEFS of a data pod, which may include one or more clusters. This feature facilitates the performance of, among other things, instant copy-free moves of volumes from one DEFS to another, for example, in connection with performing load balancing. Creating clones on remote nodes for load balancing is yet another benefit. With a global PVBN space, support for global data deduplication can also be supported rather than deduplication being limited to node-level aggregates.

It is also beneficial, in terms of performance, to avoid the use of access control mechanism, such as locks, to coordinate write accesses and write allocation among nodes generally and DEFSs specifically. Such access control mechanisms may be eliminated by specifying, at a per-DEFS level, those portions of the disaggregated storage of the storage pod to which a given DEFS has exclusive write access. For example, as described further below, a DEFS may be limited to use of only the AAs associated with (assigned to or owned by) the DEFS for performing write allocation and write accesses during a CP. Advantageously, given the visibility into the entire global PVBN space, reads can be performed by any DEFS of the cluster from all the PVBNs in the storage pod.

Each DEFS of a given cluster (or data pod, as the case may be) may start at its own superblock. As shown and described with reference to FIG. 6, a predefined AA (e.g., the first AA) in storage pod may be dedicated for superblocks. In one embodiment, a set of RAID stripes within the predefined superblock AA (e.g., the first AA of the storage pod) may be dedicated for superblocks. In this predefined superblock AA, ownership may be specified at the granularity of a single RAID stripe instead of at the AA granularity of multiple RAID stripes representing one or more GBs (e.g., between approximately 1GB and 10GB) of storage space. The location of a super block of a given DEFS can be mathematically derived using an identifier (a DEFS ID) associated with the given DEFS. Since the RAID stripe is already reserved for a super block, it can be replicated on N disks. The location of a superblock of a given DEFS can be mathematically derived using an identifier (e.g., a DEFS ID) associated with the given DEFS. Since the RAID stripe is already reserved for a superblock, it can be replicated on N disks. Similarly, the location of a DEFS label (described further below) of a given DEFS can be mathematically derived using an identifier (e.g., a DEFS ID) associated with the given DEFS.

Each DEFS has AAs associated with it, which may be thought of conceptually as the DEFS owning those AAs. In one embodiment, AAs may be tracked within an AA map and persisted within the DEFS filesystem. An AA map may include the DEFS ID in an AA index. While AA ownership information regarding other DEFSs in the cluster may be cached in the AA map of a given DEFS, which may be useful during the PVBN free path, for example, to facilitate freeing of PVBNs of an AA not owned by the given DEFS (which may arise in situations in which partial AAs are donated from one DEFS to another), the authoritative source information regarding the AAs owned by a given DEFS may be presumed to be in the AA map of the given DEFS.

In support of avoiding storage silos and supporting the more fluid use of disk space across all nodes of a cluster, DEFSs may be allowed to donate partially or completely free AAs to other DEFSs.

As described further below, each DEFS may have its own label information maintained on persistent storage. The label information may be kept in a super block or another well-known location outside of the file system.

In various examples, there can be multiple DEFSs on a RAID tree. That is, there may be a many-to-one association between DEFSs and a RAID tree, in which each DEFS may have a reference on the RAID tree. The RAID tree can still have multiple RAID groups. In various examples described herein, it is assumed the PVBN space provided by the RAID tree is continuous.

It may be helpful to have a root DEFS and a data DEFS that are transparent to other subsystems. These DEFSs may be useful for storing information that might be needed before the file system is brought online. Examples of such information may include controller (node) failover (CFO) and storage failover (SFO) properties/policies. HA is one example of where it might be helpful to bring up a controller (node) failover root DEFS first before giving back the storage failover data DEFSs. HA coordination of bringing down a given DEFS on takeover/giveback may be handled by the file system (e.g., WAFL) since the RAID tree would be up until the node is shutdown.

DEFS data structures (e.g., DEFS bit maps at the PVBN level, such as active maps and reference count (refcount) maps) may be sparse. That is, they may represent the entire global PVBN space, but only include valid truth values for PVBNs of AAs that are owned by the particular DEFS with which they are associated. When validation of these bit maps is performed by or on behalf of a particular DEFS, the bits should be validated only for the AA areas owned by the particular DEFS. When using such sparce data structures, to get the complete picture of the PVBN space, the data structures in all of the nodes should be taken into consideration. While various DEFS data structures may be discussed herein as if they were separate metafiles, it is to be appreciated, given the visibility by each node into the entire global PVBN space, one or more of such DEFS data structures may be represented as cluster-wide metafiles. Such a cluster-wide metafile may be persisted in a private inode space that is not accessible to end users and the relevant portions for a particular DEFS may be located based on the DEFS ID of the particular DEFS, for example, which may be associated with the appropriate inode (e.g., an L0 block). Similarly, the entirety of such a cluster-wide metafile may be accessible based on a cluster ID, for example, which may be associated with a higher-level inode in the hierarchy (e.g., an L1 block). In any event, each node should generally have all the information it needs to work independently until and unless it runs out of storage space or meets a predetermined or configurable threshold of a storage space metric (e.g., a free space metric or a used space metric), for example, relative to the other nodes of the cluster. At that point, as described further below, as part of a space monitoring and/or a space balancing process, the node may request a portion of AAs of DEFSs owned by one or more of such other nodes be donated so as to increase the useable storage space of one or more DEFSs of the node at issue.

FIG. 6 is a block diagram illustrating a distributed storage system architecture 600 that provides disaggregated storage in accordance with an embodiment of the present disclosure. Various architectural advantages of the proposed distributed storage system architecture and mechanisms for providing and making use of disaggregated storage include, but are not limited to, the ability to perform automatic space balancing among DEFSs, perform elastic node growth and shrinkage for a cluster, perform elastic storage growth of the storage pod, perform zero-copy file and volume move (migration), perform distributed RAID rebuild, achieve HA cost reduction using volume rehosting, create remote clones, and perform global data deduplication.

In the context of the present example, the nodes (e.g., node 610a and 610b) of a cluster, which may represent a data pod or include multiple data pods, each include respective data dynamically extensible file systems (DEFSs) (e.g., data DEFS 620a and data DEFS 620b) and respective log DEFSs (e.g., log DEFS 625a and log DEFS 625b). In general, data DEFSs may be used for persisting data on behalf of clients (e.g., client 180), whereas log DEFSs may be used to maintain an operation log or journal of certain storage operations within the journaling storage media that have been performed since the last CP.

It should be noted that while for simplicity only two nodes, which may be configured as part of an HA pair for fault tolerance and nondisruptive operations, are shown in the illustrative cluster depicted in FIG. 6, there may be one or more additional nodes in a given cluster. For example, there may be multiple HA pairs within a cluster (or a data pod of the cluster, which may represent a mechanism to limit the fault domain). As such, the description of this two-node cluster should be taken as illustrative only. Furthermore, while in some examples HA may be achieved by defining pairs of nodes within a cluster as HA partners (e.g., with one node designated as the primary node and the other designated as the secondary), in alternative examples any other node within a cluster may be allowed to step in after a failure of a given node without defining HA pairs.

As discussed above, one or more volumes (e.g., volumes 630a-m and volumes 630n-x) or LUNs (not shown) may be created by or on behalf of customers for hosting/storing their enterprise application data within respective DEFSs (e.g., data DEFSs 620a and 620b).

While additional data structures may be employed, in this example, each DEFS is shown being associated with respective AA maps (indexed by AA ID) and active maps (indexed by PVBN). For example, log DEFS 625a may utilize AA map 627a to track those of the AAs within a global PVBN space 640 of storage pod 645 (which may be analogous to storage pod 145) that are owned by log DEFS 625a and may utilize active map 626a to track at a PVBN level of granularity which of the PVBNs of its AAs are in use; log DEFS 625b may utilize AA map 627b to track those of the AAs within the global PVBN space 640 that are owned by log DEFS 625b and may utilize active map 626b to track at a PVBN level of granularity which of the PVBNs of its AAs are in use; data DEFS 620a may utilize AA map 622a to track those of the AAs within the global PVBN space 640 that are owned by data DEFS 620a and may utilize active map 621a to track at a PVBN level of granularity which of the PVBNs of its AAs are in use; and data DEFS 620b may utilize AA map 622b to track those of the AAs within the global PVBN space 640 that are owned by data DEFS 620b and may utilize active map 621b to track at a PVBN level of granularity which of the PVBNs of its AAs are in use.

In this example, each DEFS of a given node has visibility and accessibility into the entire global PVBN address space 640 and any AA (except for a predefined super block AA 642) within the global PVBN address space 640 may be assigned to any DEFS within the cluster. By extension, each node has visibility and accessibility into the entire global PVBN address space 640 via its DEFSs. As noted above, the respective AA maps of the DEFSs define which PVBNs to which the DEFSs have exclusive write access. AAs within the global PVBN space 640 shaded in light gray, such as AA 641a, can only be written to by node 610a as a result of their ownership by or assignment to data DEFS 620a. Similarly AAs within the global PVBN space 640 shaded in dark gray, such as AA 641b, can only be written to by node 610b as a result of their ownership by or assignment to data DEFS 620b.

Returning to super block 642, it is part of a super block AA (or super AA). In the context of FIG. 6, the super AA is the first AA of the storage pod 645. The super AA is not assigned to any DEFS (as indicated by its lack of shading). The super AA may have an array of DEFS areas which are dedicated to each DEFS and can be indexed by a DEFS ID. The DEFS ID may start at index 1 and in the context of the present example includes four super block and four DEFS label blocks. The DEFS label can act as a RAID label for the DEFS and can be written out of a CP and can store information that needs to be kept outside of the file system. In a pairwise HA configuration, two super blocks and two DEFS label blocks may be used by the hosting node and the other two may be used by the partner node on takeover. Each of these special blocks may have their own separate stripes.

In the context of the present example, it is assumed after establishment of the disaggregated storage within the storage pod 645 and after the original assignment of ownership of AAs to data DEFS 620a and data DEFS 620b, some AAs have been transferred from data DEFS 620a to data DEFS 620b and/or some AAs have been transferred from data DEFS 620b to data DEFS 620a. As such, the different shades of grayscale of entries within the AA maps are intended to represent potential caching that may be performed regarding ownership of AAs owned by other DEFSs in the cluster. For example, assuming ownership of a partial AA has been transferred from data DEFS 620a to data DEFS 620b as part of an ownership change performed in support of space balancing, when data DEFS 620a would like to free a given PVBN (e.g., when the given PVBN is no longer referenced by data DEFS 620a a result of data deletion or otherwise), data DEFS 620a should send a request to free the PVBN to the new owner (in this case, data DEFS 620b). This is due to the fact that in various embodiments, only the current owner of a particular AA is allowed to perform any modify operations on the particular AA.

Those skilled in the art will appreciate disaggregation of the storage space as discussed herein can be leveraged for cost-effective scaling of infrastructure. For example, the disaggregated storage allows more applications to share the same underlying storage infrastructure. Given that each DEFS represents an independent file system, the use of multiple of such DEFSs combine to create a cluster-wide distributed file system since all of the DEFSs within a cluster share a global PVBN space (e.g., global PVBN space 640). This provides the unique ability to independently scale each independent DEFS as well as enables fault isolation and repair in a manner different from existing distributed file systems.

### Example Cluster with Multiple Remote Clone Volumes

FIG. 7 is a block diagram illustrating a cluster of nodes (e.g., nodes 710a-d) in which multiple remote clone volumes (e.g., remote clones 750a-c) have been created in accordance with an embodiment of the present disclosure. In the context of the present example, nodes 710a-d (which may be analogous to analogous to nodes 110a-b of FIG. 1, node 200 of FIG. 2, and/or nodes 610a-b of FIG. 6) share storage provided by a single storage pod 745 (which may be analogous to storage pod 145 of FIG. 1 and/or storage pod 645 of FIG. 6).

As noted above, the remote volume clone technology described herein relates to the ability to create a clone of a parent volume (e.g., a WAFL volume) on a different node of the cluster. Hence, the clone (on a destination node) is “remote” from the parent volume (on a source node). However, as described further below, there is no need for internode communications when accessing data of the parent volume via the remote clone due to the local caching of a portion of metadata of the parent volume (or a snapshot thereof) on each node on which a remote clone has been created.

Various non-limiting use cases for remote clone volumes include (i) providing the ability to read one or more snapshots (of respective parent volumes) from a remote node and (ii) providing the ability to create a read-write copy of a given volume on any node in the cluster. With respect to the former, a backup copy of the snapshot can be taken from any node in the cluster without impacting a primary workload. With respect to the latter, a workflow that has a golden copy of a dataset and has a need, for example, to perform machine-learning (ML) model training based on the golden copy (or do some read and write tests on the golden copy) can spin up an instance on any node that makes use of a newly created remote clone volume of the parent volume containing the golden copy while not impacting the golden copy and not impacting the load on the system that hosts the golden copy. In this manner, the remote clone volume acts like a load sharing copy for the training workload.

In this example, remote clone volumes (e.g., remote clones 750a-c) have been created within respective DEFSs (not shown) of nodes 710b-d) from a parent volume 730 within a DEFS (not shown) of a source node (e.g., node 710a). This may have been performed, for example, to increase read throughput. Consider, for instance, each node 710a-d being capable of supporting a particular read throughput (e.g., 10 GB/s). By allowing concurrent reading of the same dataset by four different nodes an aggregate throughput of 4x the particular read throughput (e.g., 40 GB/s) may be achieved.

As discussed above, in the disaggregated architecture described herein, all the nodes of a cluster have access to all the data in the cluster – at least as far as performing reads is concerned. As such, any volume (e.g., parent volume 730) can be read from any node (e.g., any of nodes 710a-d) by caching the top of the filesystem tree on each node, for example, in the form of a frozen parent copy of the parent volume. As described further below, there are multiple approaches (two of which are described further below) for creating a remote clone volume (e.g., one of remote clone volumes 750a-c). In one embodiment, since all the nodes have access to the same global PVBN space (e.g., global PVBN space 640) of the storage pod 745 and a snapshot (not shown) of the parent volume has locked down the virtual volume block numbers (VVBNs), the buffer tree (not shown) of the remote clone volume at issue may be walked from the remote clone volume at issue using volume information copied from a snapshot (not shown) of the parent volume 730 during creation of the remote clone volume. For example, as shown, each remote clone volume contains a copy of top PVBN(s) (e.g., 732a-c) of the topmost PVBN(s) (e.g., top PVBN(s) 732) of the parent volume 730, thereby allowing reads so be performed by walking the buffer tree from the remote clone volume at issue.

As those skilled in the art will appreciate, read access to these clone copies does not need any remote access since all the content may be protected by the snapshot of the parent volume. In one example, as described further below, the path to the snapshot may be protected by context information. As a result, when there are changes to the parent volume on the source node (e.g., node 710a in this example), an auto refresh (in addition to periodic refreshes) of the data may be performed by refreshing the respective metadata of the remote clone volumes.

In one embodiment, the snapshot may use two different technologies to protect the blocks. User blocks (e.g., L0 blocks) may be protected by a traditional WAFL snapshot of the volume; and WAFL filesystem metadata blocks (e.g., L1 and higher blocks) may be protected by consistency point (CP) based context information which allows the remote (destination) node to detect any changes in the metadata and refresh the metadata as needed. Since the metadata blocks are all in memory, refreshing the metadata blocks is not usually needed unless the node at issue goes through a reboot workflow. This allows reading the remote filesystem blocks without a need for communicating with the remote nodes.

Since in the context of this example the distributed storage architecture provides all nodes 710-d with access to the same storage space, by copying the DEFS inode content from a first DEFS on the source node to a new inode on a second DEFS on a remote node within the cluster, the remote node will have access to all the data since the entire disk space is visible to all nodes of the cluster. After copying of the DEFS inode content, there are now two inodes pointing to the same tree on two different DEFSs.

Assume, for example, the inode copied is a container file inode. Then, before performing the copy of inode, a volume snapshot could be taken so the L0 content of the container file is protected on overwrite. This snapshot would not protect the L1 and higher metadata blocks of the container file on an on overwrite of the parent volume because an overwrite of an L1 and higher metadata block on the source could result in freeing the blocks being used by the tree on the remote clone. To address this issue, in one embodiment, the freeing of an L1 or higher block is avoided unless its CP count is greater than the CP count at which the snapshot was taken. Such L1 or higher blocks (and even L0 blocks) that would otherwise have been freed (i.e., those having a CP count that is less than or equal to the CP count at which the snapshot was taken) may instead be added to a log (e.g., jail 725). When the jail 725 reaches a threshold number of blocks, a refresh of the respective metadata of the remote clone volumes may be performed and the jail 725 may be reset (e.g., everything in the jail 725 up to the last CP may be freed). The remote clone volumes may alternatively or additionally be refreshed and the jail 725 may be subsequently reset at regular intervals and/or responsive to a read performed by a remote clone volume that results in a context mismatch on the remote clone volume.

### Remote Clone Volume Creation – First Approach

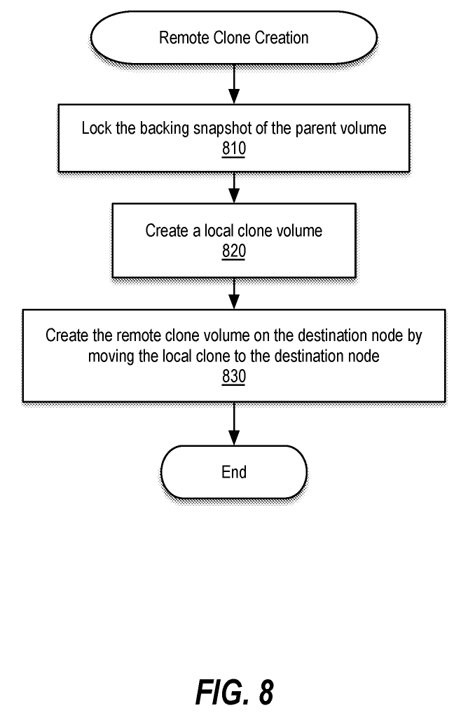

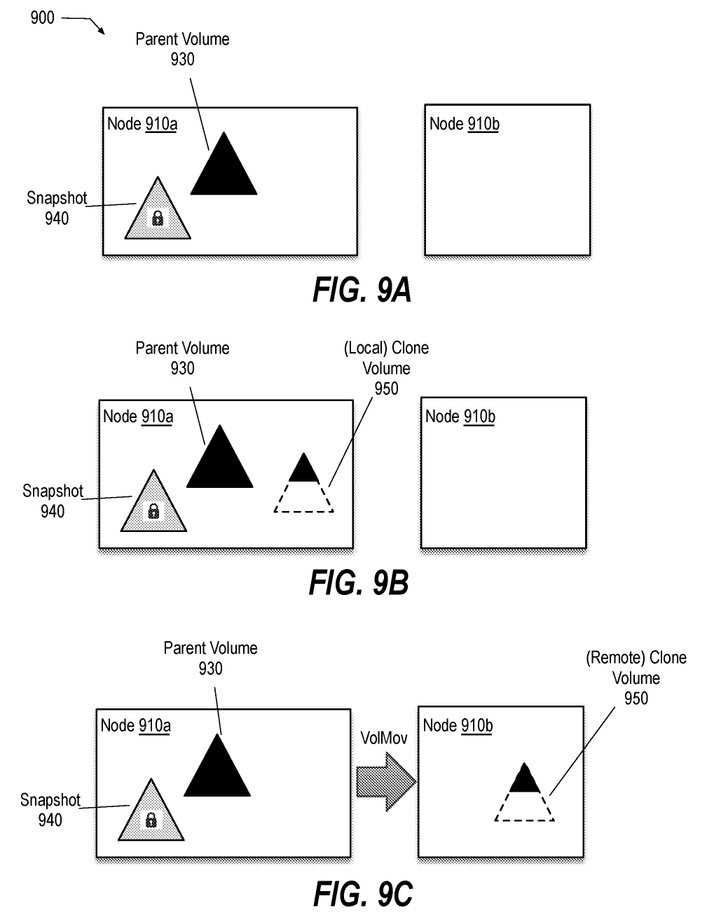

FIG. 8 is a flow diagram illustrating operations for performing remote clone volume creation in accordance with a first embodiment of the present disclosure. The processing described with reference to FIG. 8 may be performed by a distributed storage system (e.g., distributed storage system 600 of FIG. 6). In the context of the present example, the blocks of FIG. 8 will be described with reference to the block diagrams of FIGS. 9A, 9B, and 9C, which collectively conceptually illustrate step-by-step performance of the operations of FIG. 8. For sake of simplicity, only two nodes (a source node (node 910a, which may be analogous to nodes 610a and 710a) and a destination node (node 910b, which may be analogous to node 610b and one or nodes 710b-c) of the distributed storage system are shown and DEFSs (e.g., data DEFS 620a and data DEFS 620b) hosting the volumes are not shown. In this approach, a clone volume (a remote clone volume) is indirectly created on the destination node by first creating a local clone volume and then subsequently moving the local clone volume to the destination node, thereby now representing a remote clone volume.

In the context of the present example, a backing snapshot (e.g., snapshot 940) of the volume (parent volume 930, which may be analogous to one of volumes 630a-m) to be cloned is presumed to be available on the source node; otherwise, the backing snapshot may be created at the time of performance of the creation of the remote clone volume.

At block 810, the backing snapshot is locked. The backing snapshot may be locked to prevent against deletion. Deletion of the backing snapshot (prior to deletion of the remote clone (e.g., (remote) clone volume 950) or splitting of the remote clone from the parent volume 930) would otherwise leave the remote clone orphaned, hence the backing snapshot it is protected. In one example, the backing snapshot may be locked by making the backing snapshot immutable. Further discussion regarding creation and retention of immutable snapshots in the context of providing ransomware protection is provided by US Patent Application No. 18/168,739 (the “Ransomware Protection Application”), which is hereby incorporated by reference in its entirety for all purposes. While the locking operation described in the Ransomware Protection Application is described as including a parameter specifying a retention time for the snapshot at issue, in the context of the present example, the semantics may be changed to allow for the remote clone to trigger an internode communication (e.g., responsive to deletion of the remote clone or split of the remote clone from the parent volume 930) to cause the backing snapshot to be unlocked.

At block 820, a local clone volume (e.g., (local) clone volume 950) is created. The local clone volume may be created within a DEFS (not shown) of the source node based on the backing snapshot, for example, by creating pointers to the existing data blocks of the parent volume 930.

At block 830, the remote volume clone is created on the destination node (or more specifically, within a DEFS (not shown) of the destination node) by moving the local clone volume to the destination node. The local clone volume may be moved by performing a VolMov operation. In one embodiment, the VolMov operation may utilize zero-copy volume move technology, in which volume data need not be copied to move a given volume between nodes of the distributed storage system, thereby facilitating the transfer of the given volume to be performed in constant time as described in US Patent No. 12,204,784, which is hereby incorporated by reference in its entirety for all purposes.

### Remote Clone Volume Creation – Second Approach

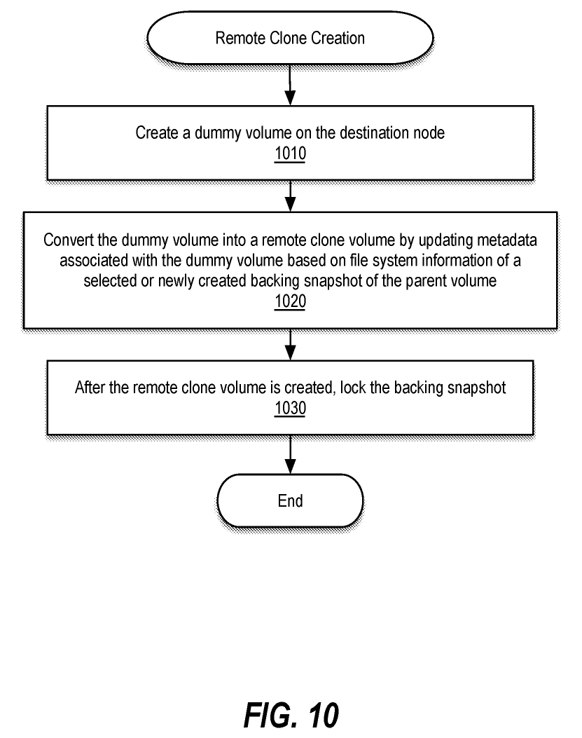

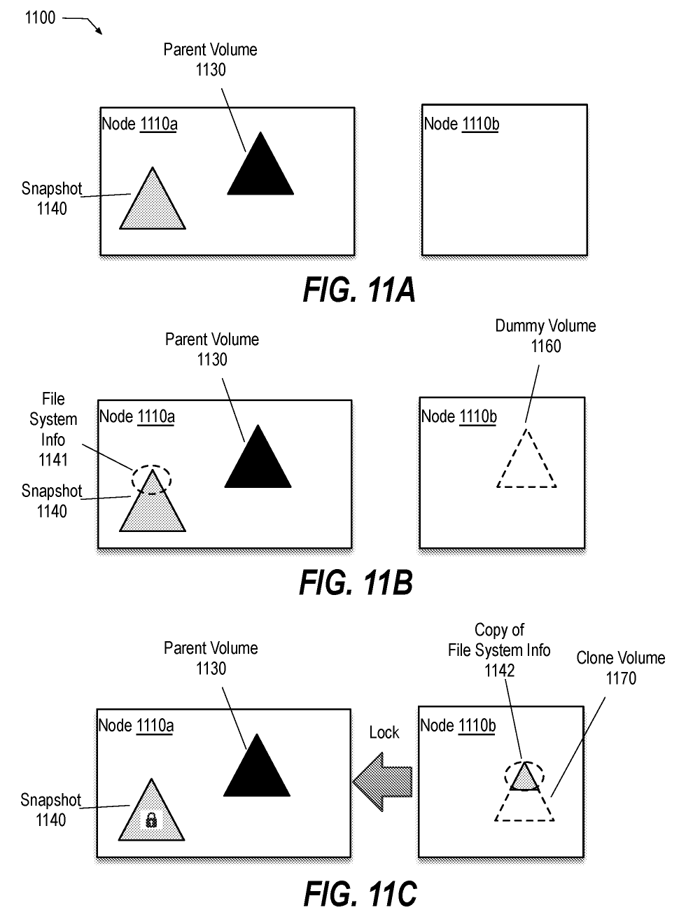

FIG. 10 is a flow diagram illustrating operations for performing remote clone volume creation in accordance with a second embodiment of the present disclosure. As above, the processing described with reference to FIG. 10 may be performed by a distributed storage system (e.g., distributed storage system 600 of FIG. 6). In the context of the present example, the blocks of FIG. 10 will be described with reference to the block diagrams of FIGS. 11A, 11B, and 11C, which collectively conceptually illustrate step-by-step performance of the operations of FIG. 10. As above, for sake of simplicity, only two nodes (a source node (node 1110a, which may be analogous to nodes 610a and 710a) and a destination node (node 1110b, which may be analogous to node 610b and one or nodes 710b-c) of the distributed storage system are shown and DEFSs (e.g., data DEFS 620a and data DEFS 620b) hosting the volumes are not shown. In this approach, a clone volume (a remote clone volume) is directly created on the destination node.

At block 1010, a dummy volume (e.g., dummy volume 1160) is created on the destination node and the super block for the dummy volume is written. The dummy volume may represent an empty volume. As those skilled in the art will appreciate, the path from a given super block to any desired data (e.g., a particular file) within the associated volume can be located by walking the super block to the desired data.

At block 1020, the dummy volume is converted into the remote clone (e.g., clone volume 1170) by updating metadata associated with the dummy volume based on file system information (e.g., file system info 1140) of a selected or a newly created backing snapshot (e.g., snapshot 1140) of the parent volume 1130 (which may be analogous to one of volumes 630a-m). For example, in one embodiment, the topmost PVBNs (e.g., top PVBN(s) 731) may be copied to create the copy of file system info 1142, for example, representing one of the copies of top PVBN(s) 732a-c.

At block 1030, after creation of the remote clone volume has been completed, the backing snapshot is locked to protect it against deletion. For example, as described above, the backing snapshot may be locked by making the backing snapshot immutable. While the locking operation described in the previously incorporated by reference Ransomware Protection Application is described as including a parameter specifying a retention time for the snapshot at issue, in the context of the present example, the locking/unlocking semantics may be changed to allow for the remote clone to trigger an internode communication (e.g., after the remote clone volume is ready for use) to cause the backing snapshot to be locked. Similarly, as above, the locking/unlocking semantics may be changed to allow for the remote clone to trigger an internode communication (e.g., responsive to deletion of the remote clone or split of the remote clone from the parent volume 1130) to cause the backing snapshot to be unlocked.

While in the context of the flow diagrams of FIG. 8 and FIG. 10 a number of enumerated blocks are included, it is to be understood that examples may include additional blocks before, after, and/or in between the enumerated blocks. Similarly, in some examples, one or more of the enumerated blocks may be omitted and/or performed in a different order.

### Reads from Remote Clones

As noted above, reads can directly happen through walking the local file system tree (e.g., an in-memory buffer tree) since all the blocks are visible from all the nodes. In some examples, the only time a read from a remote clone (e.g., remote clones 750a-c, clone volume 950, or clone volume 1170) may be redirected to the parent volume (e.g., parent volume 730, 930, or 1130) is when the parent indirect blocks of the container file blocks are overwritten. For example, if a reads hits an error, the read may result in a lookup using metadata of the parent volume (e.g., using a view of the metadata of the parent volume available to the destination node via a metadata caching mechanism, for example, metafile read caching technology). Metafile read caching is a mechanism that may be used to help cache metafiles by reading the file system of the remote node going through an older version of the file system. This older version can become stale and can be refreshed. In one embodiment, to load the metafile from remote node a location tracker for the parent volume may be made available in the clone child (the remote clone volume).

As noted above, in the context of a distributed storage system (e.g., distributed storage system 600) having disaggregated storage, e.g., represented by a storage pod (e.g., storage pod 645), all of the nodes of the cluster representing the distributed storage system have access to the same PVBN space (e.g., global PVBN space 640). Since the backing snapshot (e.g., snapshot 940 or 1140) has locked down the VVBNs, the buffer tree can be walked from the remote clone using the volume information that was copied from the backing snapshot during remote clone volume creation. In this manner, reads can be serviced using the PVBNs fetched from the local buffer tree of the remote node.

As noted above, reads may go through a context checking process to verify the correct data block is being read. For example, the context check may compare the bufftree ID, FBN, and an epoch CP count associated with the block (e.g., stored in associated context data associated with the block) to make sure that the PVBN being read has the correct data for the provided FBN for the given buffer tree.

It is possible that the read using the PVBN fetched from a remote clone volume’s buffer tree results in a context mismatch. This happens when the PVBN representing the VVBN has changed, for example, due to workflows like block reallocation, storage tiering, and the like. The VVBN is locked in the backing snapshot, but the physical location of data has changed. For example, the old PVBN has been reused to represent some other block/FBN for some other buffer tree/volume. As a result, a context mismatch has been triggered. In such cases, the read may resolve the new PVBN for the given VVBN using the parent volume’s container file so that it can reach the correct data. Since the parent volume is on a remote node, a remote container resolution workflow may be used.

According to one embodiment, the remote container resolution workflow may involve, first finding the container file handle and hosting node of the parent volume. In one example, a per-node global cache that maintains this information for all the volumes on the cluster may be leveraged. Once the container file handle has been identified, a metafile read caching module may be used to read the remote metadata view of the parent volume’s container file to find the new PVBN for the given VVBN. At this point, the read may be reissued with the new PVBN.

### Writes

In various examples described herein, writes work on remote clone volumes independently of the parent volume. There is no requirement to refer to the parent container in order to commit any new writes to a remote clone volume.

As noted above, writes to a remote clone volume do not use blocks from the source node (e.g., blocks associated with AAs assigned to a DEFS hosted by the source node). Rather, since copy-on-write file systems (of which the WAFL file system is an example) write all the modifications into a new block and write the entire tree, the remote clone volume does not need any remote access to perform write operations.

### Delete or Overwrite

Deletion of a file and/or overwrite of blocks result in PVBNs being freed from the source node. In one embodiment, these PVBNs will be freed from the source node by accumulating them within remote free logs and using an internode communication mechanisms (e.g., a persistent message queue) to send it to the destination node and free it from the appropriate bitmap.

### Block Relocation and Tiering

As will be appreciated by those skilled in the art, on overwrite of an L1 and higher metadata blocks on the source node, the blocks being used by the buffer tree of the remote clone volume may be freed. To prevent this, in one embodiment, L1 or higher blocks are not freed unless its CP count is higher than the CP count at which snapshot was taken. Instead, the PVBNs of these blocks are added into a jail log (e.g., jail 725). As noted above, since most of the Ls1 will be in memory, on free the CP count of the L1 should be available in a header of the block. In this manner, various embodiments may make sure not to trap any L1s on an overwrite. If an L1 block is not in memory, it may still be added to the jail log and freed by looking up the block.

Another workflow that has a potential to affect accessibility of data to a remote clone volume is a block reallocation flow dirtying of a block of the backing container file (e.g., the backing snapshot). For example, on a block reallocation dirty, the container file of the parent volume will get a new PVBN; however, preserving the old PVBN for an extended interval of time might be challenging with workflows like tiering in which there is an expectation of getting back the storage space. So, in some examples, the remote clone volume is refreshed at regular intervals and everything in the jail up to the last CP is freed. For example, the new content from a copy of the backing container file could be used to refresh the remote clone volume after a read encounters a context mismatch on the remote clone volume.

### Example Buffer Tree

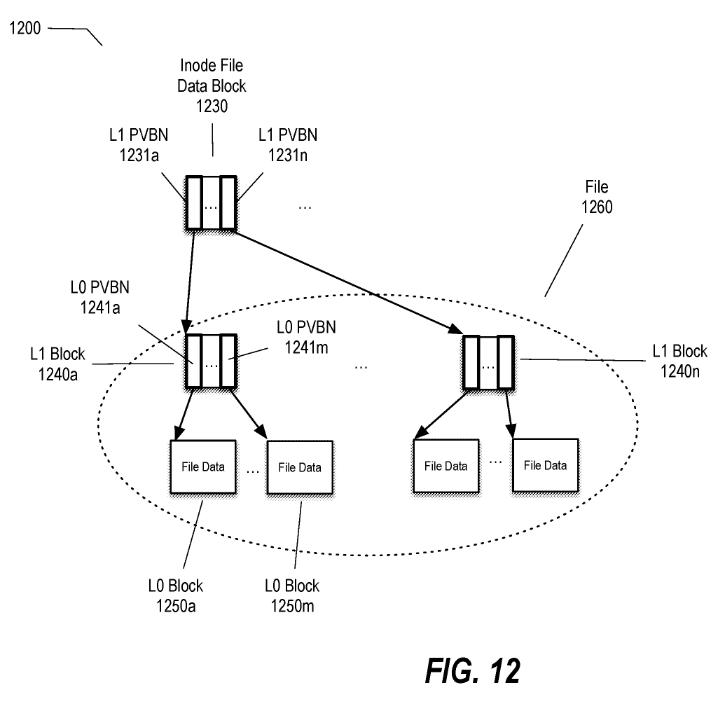

FIG. 12 is a block diagram conceptually illustrating a portion of a buffer tree 1200 containing information regarding a container or file (e.g., file 1260) in accordance with an embodiment of the present disclosure. The buffer tree 1200 may generally correspond to the file system layout shown and described with reference to FIG. 4. In this example, however, only the last layers of indirect blocks (e.g., inode file data block 1230 and L1 blocks 1240a-n) are shown to allow additional detail to be shown and described. In this example, inode file data block 1230 (which may also be referred to herein as an L2 block) is shown containing multiple L1 PVBNs (i.e., L1 PVBNs 1231a-n, each of which may also be referred to individually as an L2 entry or collectively as L2 entries) that contain the location of or a pointer to respective L1 blocks of the file 1260. Each of these L1 blocks is further shown as containing multiple L0 PVBNs (L0 PVBNs 1241a-m, each of which may also be referred to individually as an L1 entry or collectively as L1 entries) that contain the location of or a pointer to respective L0 blocks (e.g., L0 block 1250a-m) on disk that contain file data.

Embodiments of the present disclosure include various steps, which have been described above. The steps may be performed by hardware components or may be embodied in machine-executable instructions, which may be used to cause one or more processing resources (e.g., one or more general-purpose or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors (e.g., processors 222a-b) within a single computer) and storage systems containing or having network access to computer program(s) coded in accordance with various methods described herein, and the method steps associated with embodiments of the present disclosure may be accomplished by modules, routines, subroutines, or subparts of a computer program product.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device (e.g., local storage 230). Volatile media includes dynamic memory, such as main memory (e.g., memory 224). Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (e.g., system bus 223). Transmission media can also take the form of acoustic or light waves, such as those generated during radio-wave and infra-red data communications.

Various forms of media may be involved in carrying one or more sequences of one or more instructions to the one or more processors for execution. For example, the instructions may initially be carried on a magnetic disk or solid state drive of a remote computer. The remote computer can load the instructions into its dynamic memory and send the instructions over a telephone line using a modem. A modem local to the computer system can receive the data on the telephone line and use an infra-red transmitter to convert the data to an infra-red signal. An infra-red detector can receive the data carried in the infra-red signal and appropriate circuitry can place the data on bus. Bus carries the data to main memory (e.g., memory 224), from which the one or more processors retrieve and execute the instructions. The instructions received by main memory may optionally be stored on storage device either before or after execution by the one or more processors.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
providing a storage pod having a group of disks containing a plurality of Redundant Array of Independent Disks (RAID) groups, wherein an entirety of a global physical volume block number (PVBN) space associated with the storage pod is visible and accessible to all nodes of a plurality of nodes of a cluster representing a distributed storage system; and
creating, for use by a destination node of the plurality of nodes, a remote clone volume of a parent volume associated with a source node of the plurality of nodes by:
creating a snapshot of the parent volume on the source node;
locking the snapshot;
creating a local clone volume of the parent volume on the source node; and
converting the local clone volume into the remote clone volume by performing a zero-copy volume move of the local clone volume to the destination node.

2. The method of claim 1, wherein the remote clone volume increases read throughput for a dataset stored within the parent volume by allowing at least the source node and the destination node to concurrently and independently read data from the dataset.

3. The method of claim 1, wherein the zero-copy volume move comprises copying content of an index node (inode) of the first container file and to a second inode of a second container file representing the remote clone volume.

4. The method of claim 1, wherein the zero-copy volume move comprises copying metadata associated with a first container file representing the local clone volume and maintained by a file system of the source node to the destination node.

5. The method of claim 1, further comprising protecting level-1 (L1) and higher metadata blocks of a container file representing the parent volume on an overwrite of the parent volume by adding those of the L1 and higher metadata blocks, having a consistency point (CP) count less than or equal to a CP count at which the backing snapshot was taken and that would otherwise have been freed, to an on-disk log.

6. The method of claim 1, wherein the file system comprises a write-anywhere file system in which writes are performed to free blocks rather than overwriting existing blocks.

7. A method comprising:
providing a storage pod having a group of disks containing a plurality of Redundant Array of Independent Disks (RAID) groups, wherein an entirety of a global physical volume block number (PVBN) space associated with the storage pod is visible and accessible to all nodes of a plurality of nodes of a cluster representing a distributed storage system; and
creating, for use by a destination node of the plurality of nodes, a remote clone volume of a parent volume associated with a source node of the plurality of nodes by:
creating a dummy volume on the destination node;
converting the dummy volume into the remote clone volume by copying metadata associated with a backing snapshot of the parent volume to the dummy volume; and
after completion of the remote clone volume, locking the backing snapshot.

8. The method of claim 7, wherein the remote clone volume increases read throughput for a dataset stored within the parent volume by allowing at least the source node and the destination node to concurrently and independently read data from the dataset.

9. The method of claim 7, wherein the metadata comprises an index node (inode) of a first container file representing the backing snapshot and wherein said copying comprises copying content of the inode to a second inode of a second container file representing the dummy volume.

10. The method of claim 7, wherein the file system comprises a write-anywhere file system in which writes are performed to free blocks rather than overwriting existing blocks.

11. The method of claim 7, wherein the metadata comprises an inode at a top of a node tree representing the backing snapshot.

12. A distributed storage system comprising:
one or more processing resources; and
instructions that when executed by the one or more processing resources cause the distributed storage system to:
make use of a storage pod having a group of disks containing a plurality of Redundant Array of Independent Disks (RAID) groups, wherein an entirety of a global physical volume block number (PVBN) space associated with the storage pod is visible and accessible to all nodes of a plurality of nodes of a cluster representing a distributed storage system; and
create, for use by a destination node of the plurality of nodes, a remote clone volume of a parent volume associated with a source node of the plurality of nodes by:
creating a snapshot of the parent volume on the source node;
locking the snapshot;
creating a local clone volume of the parent volume on the source node; and
converting the local clone volume into the remote clone volume by performing a zero-copy volume move of the local clone volume to the destination node.

13. The distributed storage system of claim 12, wherein the remote clone volume increases read throughput for a dataset stored within the parent volume by allowing at least the source node and the destination node to concurrently and independently read data from the dataset.

14. The distributed storage system of claim 12, wherein the zero-copy volume move comprises copying content of an index node (inode) of the first container file and to a second inode of a second container file representing the remote clone volume.

15. The distributed storage system of claim 12, wherein the zero-copy volume move comprises copying metadata associated with a first container file representing the local clone volume and maintained by a file system of the source node to the destination node.

16. A non-transitory machine readable medium storing instructions, which when executed by one or more processing resources of a distributed storage system, cause the distributed storage system to:
make use of a storage pod having a group of disks containing a plurality of Redundant Array of Independent Disks (RAID) groups, wherein an entirety of a global physical volume block number (PVBN) space associated with the storage pod is visible and accessible to all nodes of a plurality of nodes of a cluster representing a distributed storage system; and
create, for use by a destination node of the plurality of nodes, a remote clone volume of a parent volume associated with a source node of the plurality of nodes by:
creating a dummy volume on the destination node;
converting the dummy volume into the remote clone volume by copying metadata associated with a backing snapshot of the parent volume to the dummy volume; and
after completion of the remote clone volume, locking the backing snapshot.

17. The non-transitory machine readable medium of claim 16, wherein the remote clone volume increases read throughput for a dataset stored within the parent volume by allowing at least the source node and the destination node to concurrently and independently read data from the dataset.

18. The non-transitory machine readable medium of claim 16, wherein the metadata comprises an index node (inode) of a first container file representing the backing snapshot and wherein said copying comprises copying content of the inode to a second inode of a second container file representing the dummy volume.

19. The non-transitory machine readable medium of claim 16, wherein the file system comprises a write-anywhere file system in which writes are performed to free blocks rather than overwriting existing blocks.

20. The non-transitory machine readable medium of claim 16, wherein the metadata comprises an inode at a top of a node tree representing the backing snapshot.
